(19) United States
(12) Patent Application Publication
(10) Pub. No.: US 2025/0045873 A1
(43) Pub. Date: Feb. 6, 2025

(54) FOVEATED SENSING

(71) Applicant: QUALCOMM Incorporated, San Diego, CA (US)

(72) Inventors: Debarati KUNDU, San Diego, CA (US); Amrit Anand AMRESH, Bangalore (IN); Animesh BEHERA, Bengaluru (IN); Chih-Chi CHENG, San Diego, CA (US); Pawan Kumar BAHETI, Bangalore (IN)

(21) Appl. No.: 18/714,536

(22) PCT Filed: Aug. 18, 2022
(86) PCT No.: PCT/US2022/075177

§ 371 Date: May 29, 2024

(30) Foreign Application Priority Data
Feb. 23, 2022 (IN) 202241009796

(51) Int. Cl. G06T 5/50; G06F 3/01; G06T 7/20; G06T 7/50; G06V 10/25; G06V 10/46

(52) U.S. Cl. CPC G06T 5/50; G06F 3/013; G06T 7/20; G06T 7/50; G06V 10/25; G06V 10/462; G06T 2207/20221; G06V 2201/07

(57) ABSTRACT

Systems and techniques are described for performing foveated sensing. In some aspects, a method (e.g., implemented by an image sensor) can include capturing sensor data for a frame associated with a scene, obtaining information corresponding to a region of interest (ROI) associated with the scene, generating a first portion (having a first resolution) of the frame corresponding to the ROI, generating a second portion of the frame having a second resolution, and outputting (e.g., to an image signal processor (ISP)) the first portion and the second portion. In some aspects, a method (e.g., implemented by an ISP) can receive, from an image sensor, sensor data for a frame associated with a scene, generating a first version (having a first resolution) of the frame based on an ROI associated with the scene, and generating a second version of the frame having a second resolution (lower than the first resolution).

### CROSS-REFERENCE TO RELATED APPLICATIONS

This application for patent is a 371 of international Patent Application PCT/US2022/075177, filed Aug. 18, 2022, which claims priority to Indian patent application No. 202241009796, filed Feb. 23, 2022, all of which are hereby incorporated by referenced in their entirety and for all purposes.

### FIELD

The present disclosure generally relates to capture and processing of images or frames. For example, aspects of the present disclosure relate to foveated sensing systems and techniques.

### BACKGROUND

Extended reality (XR) devices, such as virtual reality (VR) or augmented reality (AR) headsets, can track translational movement and rotation movement in six degrees of freedom (6DoF). Translation movement corresponds to movement in three perpendicular axes, which can be referred to as x, y, and z axes, and rotational movement is the rotation around the three axes, which can be referred to as pitch, yaw, and roll. In some cases, an XR device can include one or more image sensors to permit visual see through (VST) functions, which allow at least one image sensor to obtain images of the environment and display the images within the XR device. In some cases, the XR device with VST functions can superimpose generated content onto the images obtained within the environment.

### SUMMARY

Systems and techniques are described herein for foveated sensing. Gaze prediction algorithms may be used to anticipate where the user may look at in the subsequent frames.

Disclosed are systems, apparatuses, methods, and computer-readable media for performing foveated sensing. According to at least one example, a method is provided for generating one or more frames. The method includes: capturing, using an image sensor, sensor data for a frame associated with a scene; determining a region of interest (ROI) associated with the scene; generating a first portion of the frame corresponding to the ROI, the first portion having a first resolution; generating a second portion of the frame, the second portion having a second resolution that is lower than the first resolution; and outputting the first portion of the frame and the second portion of the frame.

In another example, an apparatus for generating one or more frames is provided that includes at least one memory (e.g., configured to store data, such as virtual content data, one or more images, etc.) and one or more processors (e.g., implemented in circuitry) coupled to the at least one memory. The one or more processors are configured to and can: capture, using an image sensor, sensor data for a frame associated with a scene; obtain information corresponding to an ROI associated with the scene; generate a first portion of the frame corresponding to the ROI, the first portion having a first resolution; generate a second portion of the frame, the second portion having a second resolution that is lower than the first resolution; and output the first portion of the frame and the second portion of the frame from the image sensor.

In another example, a non-transitory computer-readable medium is provided that has stored thereon instructions that, when executed by one or more processors, cause the one or more processors to: capture, using an image sensor, sensor data for a frame associated with a scene; obtain information corresponding to an ROI associated with the scene; generate a first portion of the frame corresponding to the ROI, the first portion having a first resolution; generate a second portion of the frame, the second portion having a second resolution that is lower than the first resolution; and output the first portion of the frame and the second portion of the frame from the image sensor.

In another example, an apparatus for generating one or more frames is provided. The apparatus includes: means for capturing sensor data for a frame associated with a scene; means for obtaining information corresponding to an ROI associated with the scene; means for generating a first portion of the frame corresponding to the ROI, the first portion having a first resolution; means for generating a second portion of the frame, the second portion having a second resolution that is lower than the first resolution; and means for outputting the first portion of the frame and the second portion of the frame.

According to at least one additional example, a method is provided for generating one or more frames. The method includes: receiving, from an image sensor, sensor data for a frame associated with a scene; generating a first version of the frame based on a ROI associated with the scene, the first version of the frame having a first resolution; and generating a second version of the frame having a second resolution that is lower than the first resolution.

In another example, an apparatus for generating one or more frames is provided that includes at least one memory (e.g., configured to store data, such as virtual content data, one or more images, etc.) and one or more processors (e.g., implemented in circuitry) coupled to the at least one memory. The one or more processors are configured to and can: receive, from an image sensor, sensor data for a frame associated with a scene; generate a first version of the frame based on an ROI associated with the scene, the first version of the frame having a first resolution; and generate a second version of the frame having a second resolution that is lower than the first resolution.

In another example, a non-transitory computer-readable medium is provided that has stored thereon instructions that, when executed by one or more processors, cause the one or more processors to: receive, from an image sensor, sensor data for a frame associated with a scene; generate a first version of the frame based on an ROI associated with the scene, the first version of the frame having a first resolution; and generate a second version of the frame having a second resolution that is lower than the first resolution.

In another example, an apparatus for generating one or more frames is provided. The apparatus includes: means for receiving, from an image sensor, sensor data for a frame associated with a scene; means for generating a first version of the frame based on an ROI associated with the scene, the first version of the frame having a first resolution; and means for generating a second version of the frame having a second resolution that is lower than the first resolution.

In some aspects, the apparatus is, is part of, and/or includes an extended reality (XR) device (e.g., a virtual reality (VR) device, an augmented reality (AR) device, or a mixed reality (MR) device) such as a head-mounted display (HMD), glasses, or other XR device, a wireless communication device such as a mobile device (e.g., a mobile telephone and/or mobile handset and/or so-called “smart phone” or other mobile device), a wearable device, a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of an image capture and processing system, in accordance with some examples;

FIG. 2A is a diagram illustrating an example of a quad color filter array, in accordance with some examples;

FIG. 2B is a diagram illustrating an example of a binning pattern resulting from application of a binning process to the quad color filter array of FIG. 2A, in accordance with some examples;

FIG. 3 is a diagram illustrating an example of binning of a Bayer pattern, in accordance with some examples;

FIG. 4 is a diagram illustrating an example of an extended reality (XR) system, in accordance with some examples;

FIG. 5 is a block diagram illustrating an example of an XR system with visual see through (VST) capabilities, in accordance with some examples;

FIG. 6A is a block diagram illustrating an example of an XR system configured to perform foveated sensing, in accordance with some examples;

FIG. 6B is a block diagram illustrating an example of an XR system with an image sensor configured to perform foveated sensing, in accordance with some examples;

FIG. 7A is a block diagram illustrating an example of an XR system with an image sensor configured to perform foveated sensing, in accordance with some examples;

FIG. 7B is a block diagram of an image sensor circuit of FIG. 7A, in accordance with some examples;

FIG. 8 is a block diagram illustrating an example of an XR system with an image sensor and an image signal processor (ISP) configured to perform foveated sensing, in accordance with some examples;

FIG. 9 is a flow diagram illustrating an example of a process for generating one or more frames using foveated sensing, in accordance with some examples;

FIG. 10 is a block diagram illustrating another example of a process for generating one or more frames using foveated sensing, in accordance with some examples; and

FIG. 11 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only, and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Systems, apparatuses, processes (also referred to as methods), and computer-readable media (collectively referred to as “systems and techniques”) are described herein for performing foveated sensing. For example, foveation is a process for varying detail in an image based on the fovea (e.g., the center of the eye's retina) that can identify salient parts of a scene and peripheral parts of the scene. In some aspects, an image sensor can be configured to capture a part of a frame in high resolution, which is referred to as a foveated region or a region of interest (ROI), and other parts of the frame at a lower resolution using various techniques (e.g., pixel binning), which is referred to as a peripheral region. In some aspects, an image signal processor can process a foveated region or ROI at a higher resolution and a peripheral region at a lower resolution. In either of such aspects, the image sensor and/or the image signal processor (ISP) can produce high-resolution output for a foveated region where the user is focusing (or is likely to focus) and can produce a low-resolution output (e.g., a binned output) for the peripheral region.

Different aspects disclosed herein can use the foveated sensing systems and techniques to reduce bandwidth and power consumption of a system, such as an extended regality (XR) system (e.g., a virtual reality (VR) headset or head-mounted display (HMD), an augmented regality (AR) headset or HMD, etc.), a mobile device or system, a system of a vehicle, or other system. For instance, aspects of the disclosure enable an XR system to have sufficient bandwidth to enable visual see through (VST) applications that use high-quality frames or images (e.g., high-definition (HD) images or video) and synthesize the high-quality frames or images with generated content, thereby creating mixed reality content. The terms frames and images are used herein interchangeably.

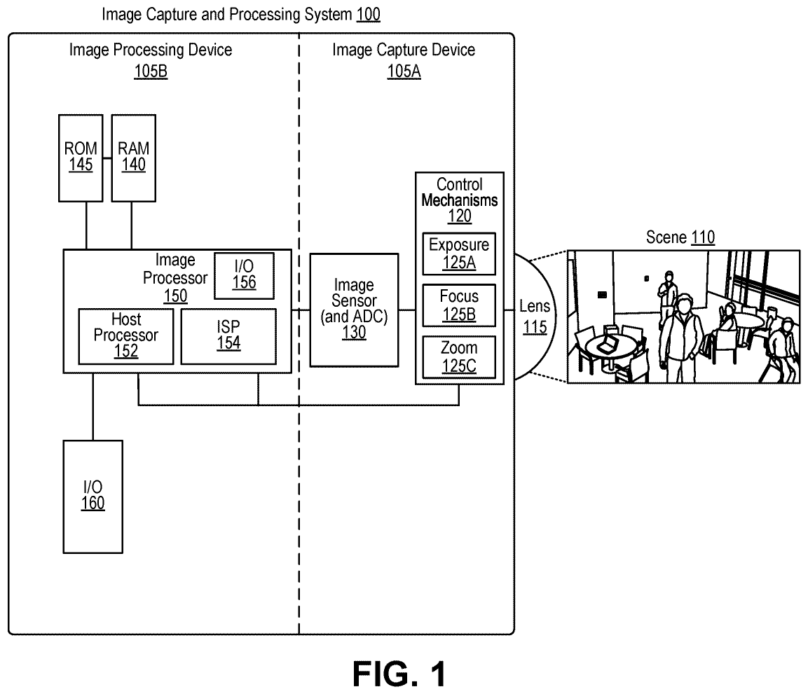

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the image capture and processing system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, high dynamic range (HDR), depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f-stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

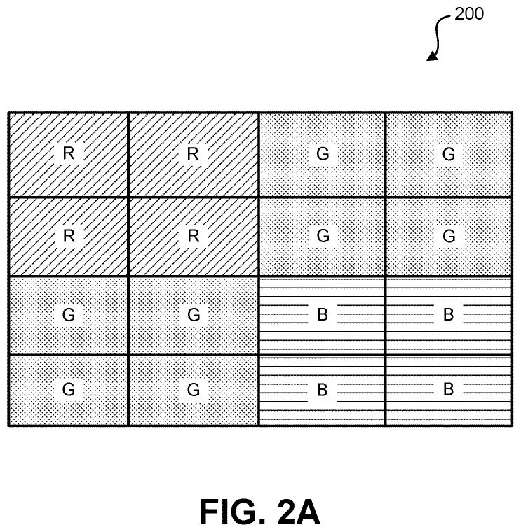

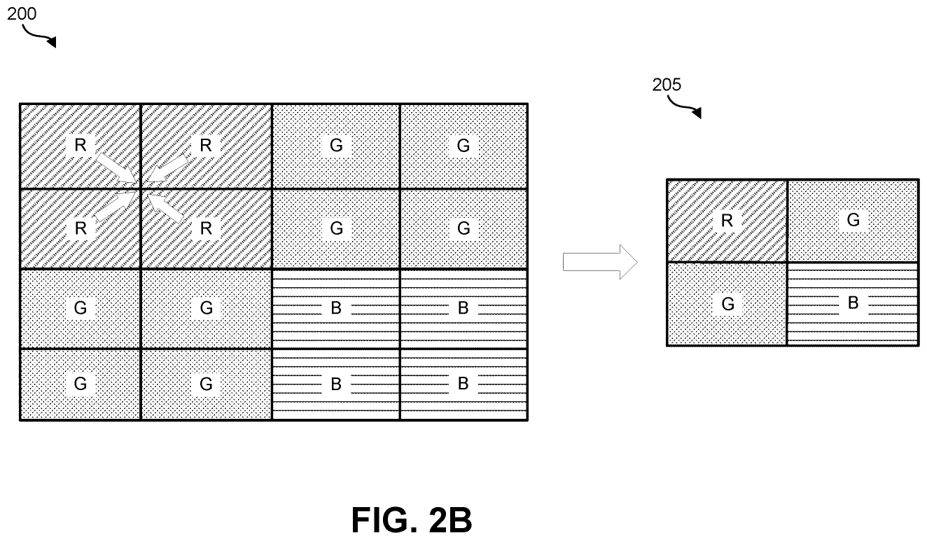

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters of a color filter array, and may thus measure light matching the color of the color filter covering the photodiode. Various color filter arrays can be used, including a Bayer color filter array, a quad color filter array (also referred to as a quad Bayer filter), and/or other color filter array. FIG. 2A is a diagram illustrating an example of a quad color filter array 200. As shown, the quad color filter array 200 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the quad color filter array 200 shown in FIG. 2A is repeated for the entire array of photodiodes of a given image sensor. As shown, the Bayer color filter array includes a repeating pattern of red color filters, blue color filters, and green color filters. Using either quad color filter array or the Bayer color filter array, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more ISPs (including ISP 154), one or more host processors (including host processor 152), and/or one or more of any other type of processor 1110 discussed with respect to the computing system 1100. The host processor 152 can be a digital signal processor (DSP) and/or other type of processor. The image processor 150 may store image frames and/or processed images in random access memory (RAM) 140/1125, read-only memory (ROM) 145/1120, a cache 1112, a memory unit 1115, another storage device 1130, or some combination thereof.

In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The host processor 152 of the image processor 150 can configure the image sensor 130 with parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. For example, the processing blocks or modules of the ISP 154 can perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The settings of different modules of the ISP 154 can be configured by the host processor 152.

The image processing device 105B can include various input/output (I/O) devices 160 connected to the image processor 150. The I/O devices 160 can include a display screen, a keyboard, a keypad, a touchscreen, a trackpad, a touch-sensitive surface, a printer, any other output devices 1935, any other input devices 1945, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

As noted above, a color filter array can cover the one or more arrays of photodiodes (or other photosensitive elements) of the image sensor 130. The color filter array can include a quad color filter array in some implementations, such as the quad color filter array 200 shown in FIG. 2A. In certain situations, after an image is captured by the image sensor 130 (e.g., before the image is provided to and processed by the ISP 154), the image sensor 130 can perform a binning process to bin the quad color filter array 200 pattern into a binned Bayer pattern. For instance, as shown in FIG. 2B (described below), the quad color filter array 200 pattern can be converted to a Bayer color filter array pattern (with reduced resolution) by applying the binning process. The binning process can increase signal-to-noise ratio (SNR), resulting in increased sensitivity and reduced noise in the captured image. In one illustrative example, binning can be performed in low-light settings when lighting conditions are poor, which can result in a high quality image with higher brightness characteristics and less noise.

FIG. 2B is a diagram illustrating an example of a binning pattern 205 resulting from application of a binning process to the quad color filter array 200. The example illustrated in FIG. 2B is an example of a binning pattern 205 that results from a 2×2 quad color filter array binning process, where an average of each 2×2 set of pixels in the quad color filter array 200 results in one pixel in the binning pattern 205. For example, an average of the four pixels captured using the 2×2 set of red (R) color filters in the quad color filter array 200 can be determined. The average R value can be used as the single R component in the binning pattern 205. An average can be determined for each 2×2 set of color filters of the quad color filter array 200, including an average of the top-right pair of 2×2 green (G) color filters of the quad color filter array 200 (resulting in the top-right G component in the binning pattern 205), the bottom-left pair of 2×2 G color filters of the quad color filter array 200 (resulting in the bottom-left G component in the binning pattern 205), and the 2×2 set of blue (B) color filters (resulting in the B component in the binning pattern 205) of the quad color filter array 200.

The size of the binning pattern 205 is a quarter of the size of the quad color filter array 200. As a result, a binned image resulting from the binning process is a quarter of the size of an image processed without binning. In one illustrative example where a 48 megapixel (48 MP or 48 M) image is captured by the image sensor 130 using a 2×2 quad color filter array 200, a 2×2 binning process can be performed to generate a 12 MP binned image. The reduced-resolution image can be upsampled (upscaled) to a higher resolution in some cases (e.g., before or after being processed by the ISP 154).

In some examples, when binning is not performed, a quad color filter array pattern can be remosaiced (using a remosaicing process) by the image sensor 130 to a Bayer color filter array pattern. For example, the Bayer color filter array is used in many ISPs. To utilize all ISP modules or filters in such ISPs, a remosaicing process may need to be performed to remosaic from the quad color filter array 200 pattern to the Bayer color filter array pattern. The remosaicing of the quad color filter array 200 pattern to a Bayer color filter array pattern allows an image captured using the quad color filter array 200 to be processed by ISPs that are designed to process images captured using a Bayer color filter array pattern.

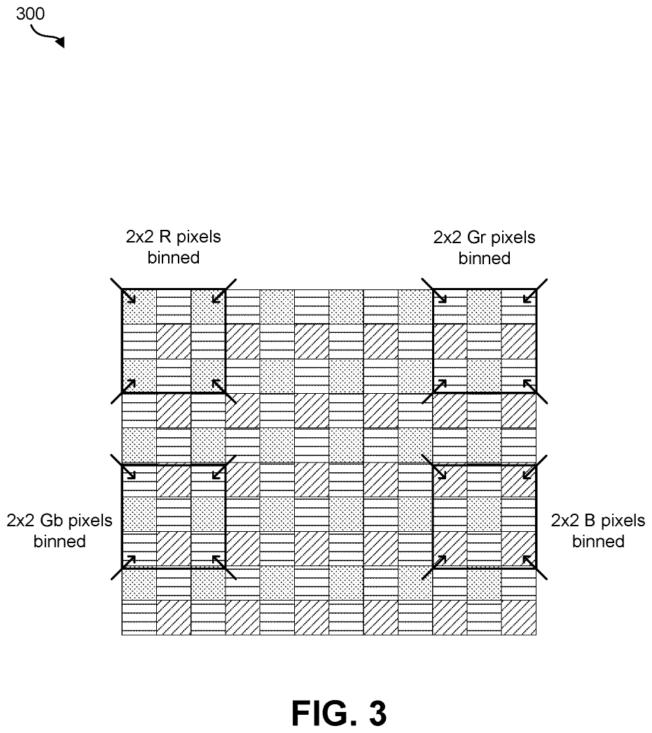

FIG. 3 is a diagram illustrating an example of a binning process applied to a Bayer pattern of a Bayer color filter array 300. As shown, the binning process bins the Bayer pattern by a factor of two both along the horizontal and vertical direction. For example, taking groups of two pixels in each direction (as marked by the arrows illustrating binning of a 2×2 set of red (R) pixels, two 2×2 sets of green (Gr) pixels, and a 2×2 set of blue (B) pixels), a total of four pixels are averaged to generate an output Bayer pattern that is half the resolution of the input Bayer pattern of the Bayer color filter array 300. The same operation may be repeated across all of the red, blue, green (beside the red pixels), and green (beside the blue pixels) channels.

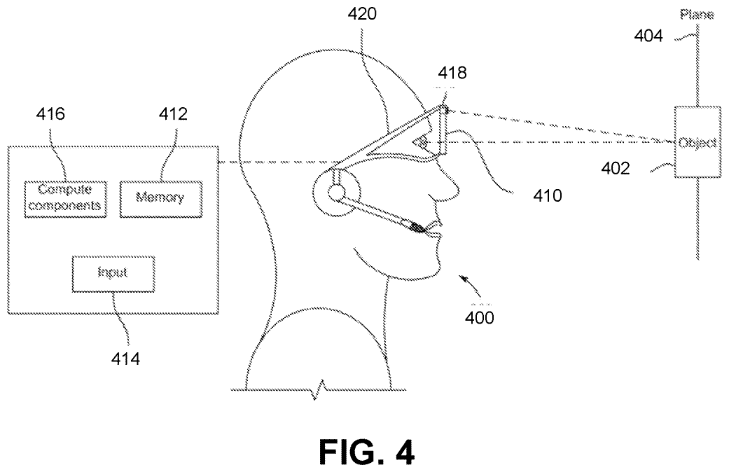

FIG. 4 is a diagram illustrating an example of an extended reality system 420 being worn by a user 400. While the extended reality system 420 is shown in FIG. 4 as AR glasses, the extended reality system 420 can include any suitable type of XR system or device, such as an HMD or other XR device. The extended reality system 420 is described as an optical see-through AR device, which allows the user 400 to view the real world while wearing the extended reality system 420. For example, the user 400 can view an object 402 in a real-world environment on a plane 404 at a distance from the user 400. The extended reality system 420 has an image sensor 418 and a display 410 (e.g., a glass, a screen, a lens, or other display) that allows the user 400 to see the real-world environment and also allows AR content to be displayed thereon. While one image sensor 418 and one display 410 are shown in FIG. 4, the extended reality system 420 can include multiple cameras and/or multiple displays (e.g., a display for the right eye and a display for the left eye) in some implementations. In some aspects, the extended reality system 420 can include an eye sensor for each eye (e.g., a left eye sensor, a right eye sensor) configured to track a location of each eye, which can be used to identify a focal point with the extended reality system 420. AR content (e.g., an image, a video, a graphic, a virtual or AR object, or other AR content) can be projected or otherwise displayed on the display 410. In one example, the AR content can include an augmented version of the object 402. In another example, the AR content can include additional AR content that is related to the object 402 or related to one or more other objects in the real-world environment.

As shown in FIG. 4, the extended reality system 420 can include, or can be in wired or wireless communication with, compute components 416 and a memory 412. The compute components 416 and the memory 412 can store and execute instructions used to perform the techniques described herein. In implementations where the extended reality system 420 is in communication (wired or wirelessly) with the memory 412 and the compute components 416, a device housing the memory 412 and the compute components 416 may be a computing device, such as a desktop computer, a laptop computer, a mobile phone, a tablet, a game console, or other suitable device. The extended reality system 420 also includes or is in communication with (wired or wirelessly) an input device 414. The input device 414 can include any suitable input device, such as a touchscreen, a pen or other pointer device, a keyboard, a mouse a button or key, a microphone for receiving voice commands, a gesture input device for receiving gesture commands, any combination thereof, and/or other input device. In some cases, the image sensor 418 can capture images that can be processed for interpreting gesture commands.

The image sensor 418 can capture color images (e.g., images having red-green-blue (RGB) color components, images having luma (Y) and chroma (C) color components such as YCbCr images, or other color images) and/or grayscale images. As noted above, in some cases, the extended reality system 420 can include multiple cameras, such as dual front cameras and/or one or more front and one or more rear-facing cameras, which may also incorporate various sensors. In some cases, image sensor 418 (and/or other cameras of the extended reality system 420) can capture still images and/or videos that include multiple video frames (or images). In some cases, image data received by the image sensor 418 (and/or other cameras) can be in a raw uncompressed format, and may be compressed and/or otherwise processed (e.g., by an ISP or other processor of the extended reality system 420) prior to being further processed and/or stored in the memory 412. In some cases, image compression may be performed by the compute components 416 using lossless or lossy compression techniques (e.g., any suitable video or image compression technique).

In some cases, the image sensor 418 (and/or other camera of the extended reality system 420) can be configured to also capture depth information. For example, in some implementations, the image sensor 418 (and/or other camera) can include an RGB-depth (RGB-D) camera. In some cases, the extended reality system 420 can include one or more depth sensors (not shown) that are separate from the image sensor 418 (and/or other camera) and that can capture depth information. For instance, such a depth sensor can obtain depth information independently from the image sensor 418. In some examples, a depth sensor can be physically installed in a same general location as the image sensor 418, but may operate at a different frequency or frame rate from the image sensor 418. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

In some implementations, the extended reality system 420 includes one or more sensors. The one or more sensors can include one or more accelerometers, one or more gyroscopes, one or more inertial measurement units (IMUs), and/or other sensors. For example, the extended reality system 420 can include at least one eye sensor that detects a position of the eye that can be used to determine a focal region that the person is looking at in a parallax scene. The one or more sensors can provide velocity, orientation, and/or other position-related information to the compute components 416. As noted above, in some cases, the one or more sensors can include at least one IMU. An IMU is an electronic device that measures the specific force, angular rate, and/or the orientation of the extended reality system 420, using a combination of one or more accelerometers, one or more gyroscopes, and/or one or more magnetometers. In some examples, the one or more sensors can output measured information associated with the capture of an image captured by the image sensor 418 (and/or other camera of the extended reality system 420) and/or depth information obtained using one or more depth sensors of the extended reality system 420.

The output of one or more sensors (e.g., one or more IMUs) can be used by the compute components 416 to determine a pose of the extended reality system 420 (also referred to as the head pose) and/or the pose of the image sensor 418. In some cases, the pose of the extended reality system 420 and the pose of the image sensor 418 (or other camera) can be the same. The pose of image sensor 418 refers to the position and orientation of the image sensor 418 relative to a frame of reference (e.g., with respect to the object 402). In some implementations, the camera pose can be determined for 6-Degrees Of Freedom (6DOF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference).

In some aspects, the pose of image sensor 418 and/or the extended reality system 420 can be determined and/or tracked by the compute components 416 using a visual tracking solution based on images captured by the image sensor 418 (and/or other camera of the extended reality system 420). In some examples, the compute components 416 can perform tracking using computer vision-based tracking, model-based tracking, and/or simultaneous localization and mapping (SLAM) techniques. For instance, the compute components 416 can perform SLAM or can be in communication (wired or wireless) with a SLAM engine (now shown). SLAM refers to a class of techniques where a map of an environment (e.g., a map of an environment being modeled by extended reality system 420) is created while simultaneously tracking the pose of a camera (e.g., image sensor 418) and/or the extended reality system 420 relative to that map. The map can be referred to as a SLAM map, and can be three-dimensional (3D). The SLAM techniques can be performed using color or grayscale image data captured by the image sensor 418 (and/or other camera of the extended reality system 420), and can be used to generate estimates of 6DOF pose measurements of the image sensor 418 and/or the extended reality system 420. Such a SLAM technique configured to perform 6DOF tracking can be referred to as 6DOF SLAM. In some cases, the output of one or more sensors can be used to estimate, correct, and/or otherwise adjust the estimated pose.

In some cases, the 6DOF SLAM (e.g., 6DOF tracking) can associate features observed from certain input images from the image sensor 418 (and/or other camera) to the SLAM map. 6DOF SLAM can use feature point associations from an input image to determine the pose (position and orientation) of the image sensor 418 and/or extended reality system 420 for the input image. 6DOF mapping can also be performed to update the SLAM Map. In some cases, the SLAM map maintained using the 6DOF SLAM can contain 3D feature points triangulated from two or more images. For example, key frames can be selected from input images or a video stream to represent an observed scene. For every key frame, a respective 6DOF camera pose associated with the image can be determined. The pose of the image sensor 418 and/or the extended reality system 420 can be determined by projecting features from the 3D SLAM map into an image or video frame and updating the camera pose from verified 4D-3D correspondences.

In one illustrative example, the compute components 416 can extract feature points from every input image or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The features points in key frames either match (are the same or correspond to) or fail to match the features points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Speed Up Robust Features (SURF), Gradient Location-Orientation histogram (GLOH), Normalized Cross Correlation (NCC), or other suitable technique.

In some examples, virtual objects (e.g., AR objects) can be registered or anchored to (e.g., positioned relative to) the detected features points in a scene. For example, the user 400 can be looking at a restaurant across the street from where the user 400 is standing. In response to identifying the restaurant and virtual content associated with the restaurant, the compute components 416 can generate a virtual object that provides information related to the restaurant. The compute components 416 can also detect feature points from a portion of an image that includes a sign on the restaurant, and can register the virtual object to the feature points of the sign so that the AR object is displayed relative to the sign (e.g., above the sign so that it is easily identifiable by the user 400 as relating to that restaurant).

The extended reality system 420 can generate and display various virtual objects for viewing by the user 400. For example, the extended reality system 420 can generate and display a virtual interface, such as a virtual keyboard, as an AR object for the user 400 to enter text and/or other characters as needed. The virtual interface can be registered to one or more physical objects in the real world. However, in many cases, there can be a lack of real-world objects with distinctive features that can be used as reference for registration purposes. For example, if a user is staring at a blank whiteboard, the whiteboard may not have any distinctive features to which the virtual keyboard can be registered. Outdoor environments may provide even less distinctive points that can be used for registering a virtual interface, for example based on the lack of points in the real world, distinctive objects being further away in the real world than when a user is indoors, the existence of many moving points in the real world, points at a distance, among others.

In some examples, the image sensor 418 can capture images (or frames) of the scene associated with the user 400, which the extended reality system 420 can use to detect objects and humans/faces in the scene. For example, the image sensor 418 can capture frames/images of humans/faces and/or any objects in the scene, such as other devices (e.g., recording devices, displays, etc.), windows, doors, desks, tables, chairs, walls, etc. The extended reality system 420 can use the frames to recognize the faces and/or objects captured by the frames and estimate a relative location of such faces and/or objects. To illustrate, the extended reality system 420 can perform facial recognition to detect any faces in the scene and can use the frames captured by the image sensor 418 to estimate a location of the faces within the scene. As another example, the extended reality system 420 can analyze frames from the image sensor 418 to detect any capturing devices (e.g., cameras, microphones, etc.) or signs indicating the presence of capturing devices, and estimate the location of the capturing devices (or signs).

The extended reality system 420 can also use the frames to detect any occlusions within a field of view (FOV) of the user 400 that may be located or positioned such that any information rendered on a surface of such occlusions or within a region of such occlusions are not visible to, or are out of a FOV of, other detected users or capturing devices. For example, the extended reality system 420 can detect the palm of the hand of the user 400 is in front of, and facing, the user 400 and thus within the FOV of the user 400. The extended reality system 420 can also determine that the palm of the hand of the user 400 is outside of a FOV of other users and/or capturing devices detected in the scene, and thus the surface of the palm of the hand of the user 400 is occluded from such users and/or capturing devices. When the extended reality system 420 presents any AR content to the user 400 that the extended reality system 420 determines should be private and/or protected from being visible to the other users and/or capturing devices, such as a private control interface as described herein, the extended reality system 420 can render such AR content on the palm of the hand of the user 400 to protect the privacy of such AR content and prevent the other users and/or capturing devices from being able to see the AR content and/or interactions by the user 400 with that AR content.

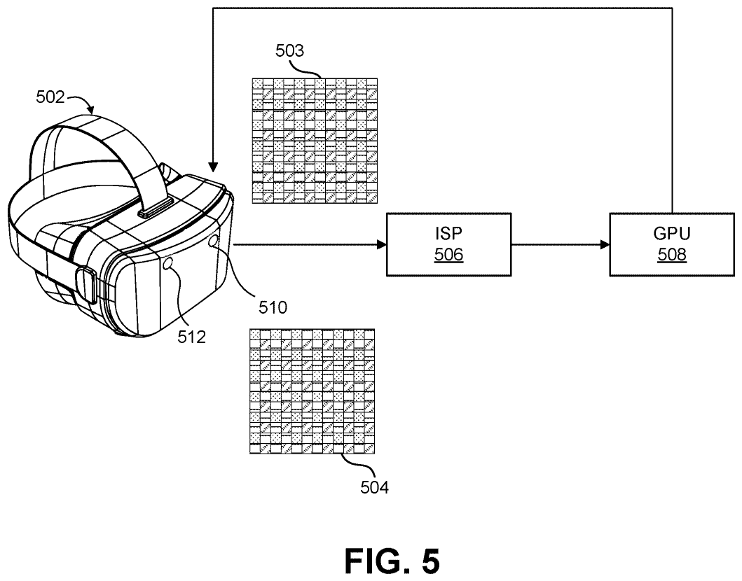

FIG. 5 illustrates an example of an XR system 502 with VST capabilities that can generate frames or images of a physical scene in the real-world by processing sensor data 503, 504 using an ISP 506 and a GPU 508. As noted above, virtual content can be generated and displayed with the frames/images of the real-world scene, resulting in mixed reality content.

In the example XR system 502 of FIG. 5, the bandwidth requirement that is needed for VST in XR is high. There is also high demand for increased resolution to improve visual fidelity of the displayed frames or images, which requires a higher capacity image sensor, such as a 16 Megapixel (MP) or 20 MP image sensor. Further, there is demand for increased framerate for XR applications, as lower framerates (and higher latency) can affect a person's senses and cause real world effects such as nausea. Higher resolution and higher framerates may result in an increased memory bandwidth and power consumption beyond the capacity of some existing memory systems.

In some aspects, an XR system 502 can include image sensors 510 and 512 (or VST sensors) corresponding to each eye. For example, a first image sensor 510 can capture the sensor data 503 and a second image sensor 512 can capture the sensor data 504. The two image sensors 510 and 512 can send the sensor data 503, 504 to the ISP 506. The ISP 506 processes the sensor data (to generate processed frame data) and passes the processed frame data to the GPU 508 for rendering an output frame or image for display. For example, the GPU 508 can augment the processed frame data by superimposing virtual data over the processed frame data.

In some cases, using an image sensor with 16 MP to 20 MP at 90 frames per second (FPS) may require 5.1 to 6.8 Gigabits per second (Gbps) of additional bandwidth for the image sensor. This bandwidth may not be available because memory (e.g., Double Data Rate (DDR) memory) in current systems is typically already stretched to the maximum possible capacity. Improvements to limit the bandwidth, power, and memory are needed support mixed reality application using VST.

In some aspects, human vision sees only a fraction of the field of view at the center (e.g., 10 degrees) with high resolution. In general, the salient parts of a scene draw human attention more than the non-salient parts of the scene. Illustrative examples of salient parts of a scene include moving objects in a scene, people or other animated objects (e.g., animals), faces of a person, or important objects in the scene such as an object with a bright color.

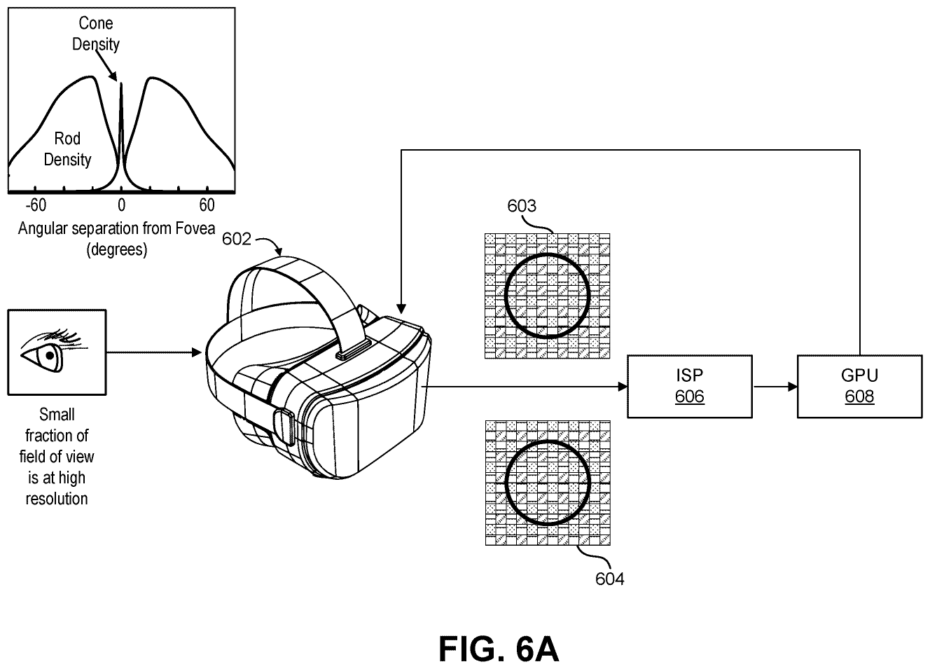

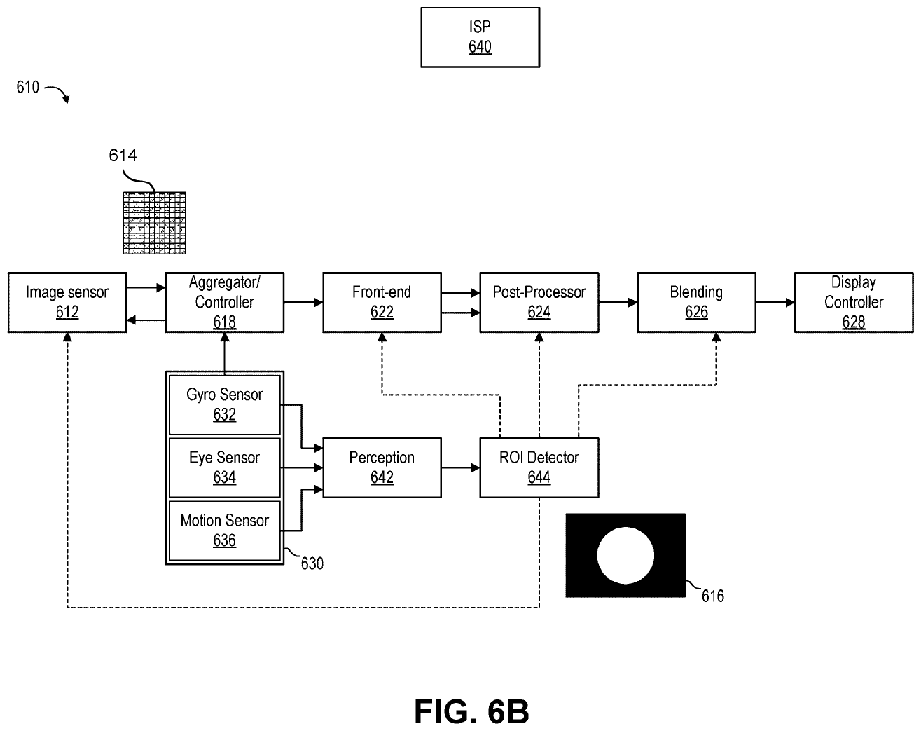

As noted above, systems and techniques are disclosed herein that use foveation sensing, which can reduce bandwidth and power consumption of a system (e.g., an XR system, mobile device or system, a system of a vehicle, etc.). FIG. 6A is a block diagram illustrating an example of an XR system 602 configured to perform foveated sensing in accordance with some examples. While examples are described herein with respect to XR systems, the foveated sensing systems and techniques can be applied to any type of system or device, such as a mobile device, a vehicle or component/system of a vehicle, or other system. The foveated sensing can be used to generate a frame or image with varying levels of detail or resolution based on a region of interest (ROI) determined based on salient part(s) of a scene (e.g., determined based on a fovea or the center of a user's retina, based on object detection, or using other techniques) and peripheral parts of the scene.

In some aspects, an image sensor can be configured to capture a part of a frame in high resolution (corresponding to the ROI, also referred to as a foveated region), and other parts of the frame (referred to as a peripheral region) at a lower resolution using various techniques such as binning. As shown in FIG. 6A, ROIs (shown as circles) are identified within sensor data 603 and sensor data 604. The area or region outside of the ROIs corresponds to the peripheral region. In some cases, the image sensor (e.g., of the XR system 602 of FIG. 6A) can produce a high-resolution output for a foveated region where the user is focusing (or is likely to focus) and can produce a low-resolution output for the peripheral region by combining pixels (e.g., by binning multiple pixels). In some examples, the foveated region of the frame and the peripheral region of the frame can be output to an ISP (e.g., the ISP 606 of the XR system 602) or other processor on two different virtual channels. In one illustrative example, by reducing the resolution on the peripheral region, an effective resolution of 16 MP-20 MP at 90 fps can be reduced to 4 MP, which can be supported by the current architecture in terms of computational complexity, DDR bandwidth, and power requirements.

Additionally or alternatively, in some aspects, an ISP can save on power and bandwidth by processing the salient parts of the scene at a higher resolution and the non-salient pixels at a lower resolution. In such aspects, the image sensor may output full resolution frames to the ISP. The ISP can be configured to bifurcate a single frame received from the image sensor into a salient portion of a frame (corresponding to the ROI) and a peripheral portion of the frame (outside of the ROI). The ISP can then process the salient parts of the scene (corresponding to the ROI) at the higher resolution and the non-salient parts of the scene (outside of the ROI) at the lower resolution.

In some aspects, various types of information can be used to identify the ROI corresponding to a salient region of a scene. For example, gaze information (e.g., captured by a gaze sensor or multiple gaze sensors) can identify the salient region, which can be used as the ROI. In another example, an object detection algorithm can be used to detect an object as the salient region, which can be used as the ROI. In one illustrative example, a face detection algorithm can be used to detect one or more faces in a scene. In other examples, depth map generation algorithms, human visual perception guided saliency map generation algorithms, and/or other algorithms or techniques can be used to identify salient regions of a scene that can be used to determine the ROI.

In some aspects, a mask (e.g., a binary or bitmap mask or image) can be used to indicate the ROI or salient region of a scene. For instance, a first value (e.g., a value of 1) for pixels in the mask can specify pixels within the ROI and a second value (e.g., a value of 0) for pixels in the mask can specify pixels in the peripheral region (outside of the ROI). In one illustrative example, the mask can include a first color (e.g., a black color) indicating a peripheral region (e.g., a region to crop from a high-resolution image) and a second color (e.g., a white color) indicating the ROI. In some cases, ROI can be a rectangular region (e.g., a bounding box) identified by the mask. In some cases, the ROI can be a non-rectangular region. For instance, instead of specifying a bounding box, the start and end pixels of each line (e.g., each line of pixels) in the mask can be programmed independently to specify whether the pixel is part of the ROI or outside of the ROI.

The systems techniques disclosed herein are related to foveated sensing, which is distinct from foveated rendering that can reduce computational complexity by cropping and rendering a part of the scene. In some cases, foveated rendering is technology related to how a scene is rendered before output to reduce computation time, which may for example be relevant to real time 3D rendered applications (e.g., games). The foveated sensing systems and techniques described herein are different from foveated rendering, at least in part because foveated sensing changes the properties of the frame/image output by an image sensor (or ISP) and uses properties of the human visual system to improve bandwidth capacity in a system with a limited bandwidth to provide higher resolution content.

In some cases, a dilation margin (e.g., of the salient region or ROI) in a mask can be adjusted (e.g., enlarged) based on motion direction, saliency or ROI, or other factors and depth in the processing pipeline. Modifying the margin of the mask can reduce slight imperfections in ROI detection, while reducing processing power and power consumption. In some cases, such as due to the latency between sensing and saliency detection, sensor feedback (e.g., based on head motion if eye keeps tracking the same object), such as from a gyrometer, IMU, or other sensor, can be sent to an aggregator/controller for rapidly adjusting the dilation of the ROI.

In some aspects, multiple sensors can process different parts of the scenes at different resolutions that are subsequently aligned (e.g., using an image alignment engine) and merged (e.g., by a GPU, such as the GPU 608 of the XR system 602 of FIG. 6A) before rendering to the display.

In some cases, full-resolution and foveated ROI frames can be interleaved and, after motion compensation, frames will be rendered to the display (e.g., by the GPU, such as the GPU 608 of the XR system 602 of FIG. 6A). For example, an ISP may receive alternating frames, with either foveated, full resolution, or binned resolution, and the frames can be blended using motion compensation (e.g., based on optical flow, block-based motion compensation, machine learning, etc.) when there is a high degree of temporal coherence between adjacent frames. For instance, the image sensor may output a first frame having full resolution, a second frame having only the portion of the frame within the ROI, a third frame with full resolution, a fourth frame having only the portion of the frame within the ROI, and so on. In one example implementation, the image sensor may provide the frames on a single channel and alternate between full resolution capture and foveated ROI capture, extract the salient region (or ROI) of the full resolution frame, and blend it with the full-resolution frame after performing motion compensation.

As noted above, in some aspects, the salient parts of a frame (e.g., for a scene) can be detected based on at least one of a gaze of the user, objected detection algorithms, face detection algorithms, depth map generation algorithms, and human visual perception guided saliency map generation algorithms. In some aspects, the gaze prediction algorithms may be used to anticipate where the user may look at in the subsequent frames which can reduce latency or the HMD. In some cases, the gaze information can also be used to preemptively fetch or process only the relevant parts of the scene to reduce complexity of the various computations performed at the HMD.

As noted above, VST applications can exceed memory bandwidth based on high framerates and thermal budgets. Foveated sensing can be configured based on various aspects. In one aspect, an application that implements VST in conjunction with 3D rendered images may determine that the framerate of the image sensor exceeds a memory bandwidth and provides an instruction (e.g., to a processor or an ISP) to trigger foveated sensing at the image sensor or the ISP. When the application exits or discontinues rendering of images using VST, the application may provide an instruction to end foveated sensing. In another aspect, a processor may determine that a required framerate (e.g., a setting of an XR system may specify a minimum resolution) for image sensor will exceed a maximum bandwidth of the memory. The processor can provide an instruction to image sensor or ISP to increase bandwidth based on foveating a frame into a salient region and a peripheral region.

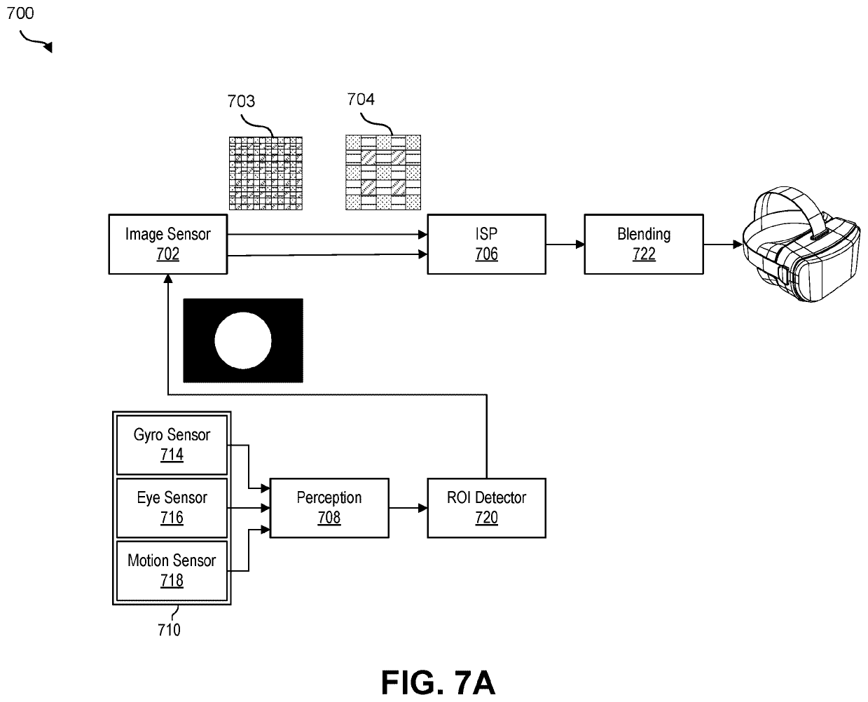

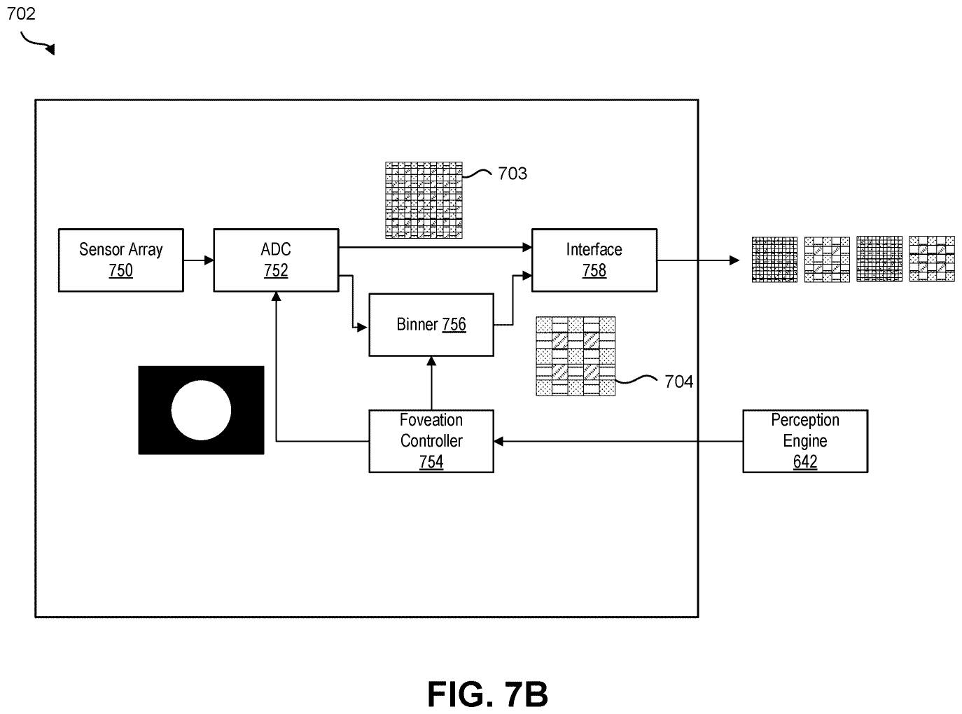

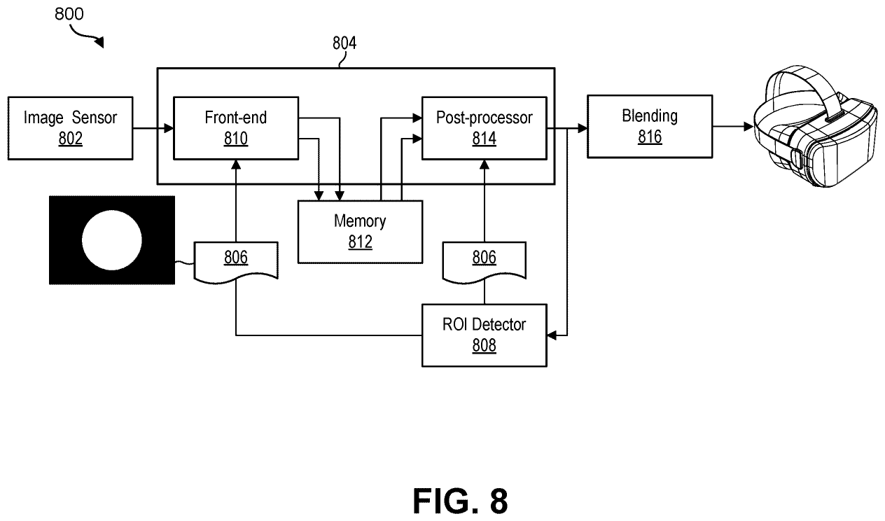

FIG. 6B illustrates a conceptual block diagram of an example XR system 610 with an image sensor that provides foveated portions of a frame in accordance with various aspects of the disclosure. The XR system 610 can be configured to provide foveation using different techniques according to the various aspects described below. For purpose of illustration, dashed lines can indicate optional connections within the XR system 610 according to the various aspects. In one aspect, a mask 616 can be provided to an image sensor 612 to perform the foveation. An example of foveation at the image sensor 612 is described below with reference to FIGS. 7A and 7B. In other aspects, the mask 616 can be provided to the front-end engine 622 of an ISP to perform the foveation as further described below with reference to FIG. 8. The mask 616 may also be provided to the post-processor 624 and blending engine 626 for post processing operations (e.g., filtering, sharpening, color enhancement, etc.). For example, full resolution and foveated frames can be interleaved, and the mask 616 facilitate blending a portion of the frames based on the mask.

The XR system 610 includes one image sensor 612 or in some cases at least two image sensors (or VST sensors) configured to capture image data 614. For example, the one or more image sensors 612 may include a first image sensor configured to capture images for a left eye and a second image sensor configured to capture images for a right eye.

In one illustrative aspect, the one or more image sensors may receive a mask 616 that identifies an ROI (salient region) that can be used with the image data to generate two different portions of a single frame. In some aspects, the mask 616 is used to crop the peripheral region from the frame to create a salient portion of the frame based on the ROI. In some cases, one or more image sensors can produce a high-resolution output for the ROI (or foveated region) and a low-resolution (e.g., binned) output for the peripheral region. As noted above, the one or more image sensors may output the high-resolution output for the ROI and the low-resolution output in two different virtual channels, which can reduce traffic on the PHY.

In one illustrative aspect, a virtual channel, which may also be referred to as a logical channel, is an abstraction that allows resources to be separated to implement different functions, such as a separate channel for a salient region and a background region. An illustrative example of a virtual channel within hardware can be a logical division of resources, such as time multiplexing. For example, a camera serial interface (CSI) allows may allow time division multiplexing of the interface to aggregate resources, such as connect multiple image sensors to an image signal processor. In one illustrative aspect, the image sensor can be configured to use two different time slots and an ISP can process the images based on the virtual channel (e.g., based on the time slot). In some aspects, the image sensor can be configured to use a single channel for non-foveated image capture, two logical channels (e.g., virtual) channels for foveated image capture.

In some aspects, the virtual channel can be implemented in software using different techniques, such as data structures that implement an interface. In such an aspect, an implementation of the interface can be different. For example, an interface IGenericFrame can define a function PostProcess( ) and a SalientFrame, which implements IGenericFrame, can implement the function PostProcess( ) differently from an PostProcess( ) implementation in BackgroundFrame, which also implements IGenericFrame.

In some cases, mask 616 may or may not be used to generate a frame for the peripheral region. In one example, the peripheral region can be binned within the pixel array to create a second portion of the frame at a lower resolution without the mask 616. In this example, the frame contains all content associated with the peripheral region and the salient region. In other cases, the mask 616 can be applied to the binned image to reduce various post-processing steps described below. For example, applying the mask applied to the binned image to remove the salient region from the binned image. Binning can include combining adjacent pixels, which can improve SNR and the ability to increase frame rate, but reduces the resolution of the image. Examples of binning are described above with reference to FIGS. 2-3.

In some cases, a gyrometer can detect rotation of the XR system 610 and provide rotation information to the aggregator/controller, which then provides the rotation information to the VST sensors to adjust the ROI. In some cases, the mask 616 can be associated with a previous frame and rotation information and the image sensor 612 can preemptively adjust the ROI based on the rotation to reduce latency and prevent visual artifacts in the XR system 610 that can negatively affect the wearer of the XR system 610.

The one or more image sensors 612 (e.g., one or more VST sensors) is configured to provide the images and the aggregator/controller 618 illustrated in FIG. 6B can be configured to provide the salient portion of the frame and the peripheral portion of the frame on different virtual channels to a front-end engine 622 of an ISP and a post-processing engine 624 of the ISP. In some aspects, the front-end engine 622 is configured to receive the images from the image sensor and store the images in a queue (e.g., a first-in first-out FIFO buffer) in a memory and provide the images to a post-processor 624 using a virtual channel that corresponds to the type of image. In one illustrative example, the ISP (e.g., the front-end engine 622 and/or the post-processing engine 624) may include a machine learning (ML) model that performs the image processing of the portions of the frame. In some cases, a first virtual channel can be configured to transmit the salient portion of the frame, and a second virtual channel can be configured to transmit the peripheral portion of the frame. In some cases, the front-end engine 622 and/or the post-processing engine 624 uses the different virtual channels to distinguish different streams to simplify management of the front-end engine 622 and/or post-processing engine 624 functions.

In some aspects, the post-processing engine 624 can process the salient portion of the frame and the peripheral portion of the frame to improve various aspects of the image data, such as color saturation, color balance, warping, and so forth. In some aspects, different parameters can be used for the salient and non-salient parts of the frame, resulting in different qualities for the different parts of the frame. For example, the front-end engine or the post-processing engine can perform sharpening on the salient portion of the frame to improve distinguishing edges. The front-end engine 622 or the post-processing engine 624 may not perform sharpening on the peripheral portion of the frame in some cases.

The XR system 610 can also include a collection of sensors 630 such as a gyroscope sensor 632, eye sensors 634, and head motion sensors 636 for receiving eye tracking information and head motion information. The various motion information, including motion from the gyroscope sensor 632, can be used to identify a focal point of the user in a frame. In one aspect, the sensors 630 provide the motion information to the perception stack 642 of an ISP to process sensor information and synthesize information for detecting the ROI. For example, the perception stack synthesizes the motion information to determine gaze information such as a direction of the gaze of the wearer, a dilation of the wearer, etc. The gaze information is provided to a ROI detection engine 644 to detect an ROI in the frame. In some cases, the ROI can be used to generate the mask 616 for the next frame to reduce latency. In some cases, the perception stack 642 and/or the ROI detection engine 644 can be integral to the ISP or can be computed by another device, such as a neural processing unit (NPU) configured to perform parallel computations.

In some aspects, the mask 616 can be provided to the post-processing engine 624 to improve image processing of the salient portion of the frame and the peripheral portion of the frame. After the salient portion of the frame and the peripheral portion of the frame are processed, the salient portion of the frame and the peripheral portion of the frame are provided to a blending engine 626 (e.g., a GPU) for blending the salient portion of the frame and the peripheral portion of the frame into a single output frame. In some aspects, the blending engine 626 can superimpose rendered content (e.g., from the GPU) onto or into the frame to create a mixed-reality scene and output the frame to a display controller 628 for display on the XR system 610. A single output frame is provided as the frame for presentation on a display (e.g., to a display for a corresponding eye).

Although a single frame is described above, the above-described process can be performed for each frame from each image sensor to yield one or more output frames (e.g., a left output frame and a right output frame). In the event left and right output frames are generated for the XR system 610, both the left output frame and the right output frame are presented concurrently to the user of the XR system 610.

The illustrative example of FIG. 6B provides a feedback loop to facilitate obtaining the foveation information from the final rendered image to provide information to the image sensor (e.g., the VST sensor) for a next frame.

FIG. 7A illustrates an example block diagram of an XR system 700 with an image sensor 702 (e.g., a VST sensor) configured to provide foveated portions of a frame to an ISP in accordance with some examples. The image sensor 702 in FIG. 7A provides a high-resolution output 703 for a salient region (corresponding to the ROI) of one or more frames on a first virtual stream to an ISP 706 and a low-resolution output 704 (lower than the high-resolution output) for one or more peripheral regions of one or more frames on a second virtual stream. The ISP 706 is configured to process the salient region and the peripheral region (e.g., a background region) differently and may apply various processing techniques to the different regions. For example, the ISP 706 may use the foveated pixels (e.g., the salient region) as an input into various artificial intelligence (AI) engines to perform various functions such as segmentation, tone-mapping, and object detection. For example, the ISP may be configured to recognize a face within the salient region and apply a particular tone-mapping algorithm to improve image quality. By offloading various functions to an AI engine trained for specific functions, the ISP 706 can decrease the processing load on the DSP and reduce power consumption. Combining foveated pixels with the saliency map help preferentially tune the image to improve image quality of the final rendered image.

In the illustrative example of FIG. 7A, a perception engine 708 is configured to receive motion information from a collection of sensors 710, which includes a gyroscope sensor 714, an eye sensor 716, and a motion sensor 718 (e.g., an accelerometer). The motion information may include gyroscope information (e.g., head pose information), eye tracking information, head tracking (e.g., head position information), and/or other information (e.g., object detection information, etc.). The perception engine 708 can process the motion information to determine gaze information (e.g., direction, dilation, etc.) and the ROI detector 720 can predict a ROI based on the gaze information. In some aspects, the perception engine 708 may be an ML-based model (e.g., implemented using one or more neural networks) configured to identify a linear (e.g., rectangular) or non-linear (e.g., elliptical) region associated with a frame based on the various techniques described above. In other cases, the ROI detection may be performed by a conventional algorithm that is logically deduced.

In the illustrative example of FIG. 7A, the ISP 706 is configured to receive both virtual streams (e.g., one stream with the ROI/salient region and a second stream with the peripheral region(s)) and process the salient regions of the one or more frames to improve the image (e.g., edge detection, color saturation). In some examples, the ISP 706 is configured to omit one or more image signal processing operations for the peripheral region of the frames. In some examples, the ISP 706 is configured to perform fewer image signal processing operations for the peripheral region of the frame(s) (e.g., using only tone correction) as compared to image signal processing operations performed for the ROI/salient region of the frame(s). In one illustrative example, the ISP 706 may apply a local tone mapping to a salient region, and the ISP 706 can omit a tone-mapping algorithm or implement a simpler tone-mapping to the peripheral region. The ISP 706 can apply a more sophisticated edge preserving filter to the salient region that preserves details, while applying a weaker filter to the peripheral region. For example, the weaker filter may use kernels having a smaller area and provides less improvement, but is a more efficient operation.

In some aspects, the ISP 706 may be configured to control the foveation (e.g., the salient region) parameters based on power consumption requirements. Foveation parameters can include various setting such as object detection methods, image correction to correct optical lens effects, the dilation margin (e.g., the size of the foveation region), parameters related to merging the salient region and the peripheral region, and so forth. For example, the ISP 706 may control the processing of the salient region and the peripheral region to suitably balance power consumption and image quality. The ISP 706 may also control the dilation margin of the mask to reduce the size of the salient region and increase the size of the peripheral region to further reduce power consumption by the ISP 706.

The salient regions and peripheral regions are provided to a blending engine 722 that is, for example, implemented by a GPU, to combine the images based on the coordinates of the images. In some aspects, the blending engine 722 (e.g., GPU) can be configured to receive information associated with the mask for the corresponding frames. The blending engine 722 may also be configured to perform various operations based on the mask. For example, a more sophisticated upscaling technique (e.g., bicubic) may be applied to the salient region, and a simpler upscaling technique (e.g., bilinear) may be applied to the peripheral region.

FIG. 7B illustrates an example block diagram of an image sensor 702 (e.g., a VST sensor) configured to provide foveated portions of a frame to an ISP in accordance with some examples. The image sensor 702 includes a sensor array 750 that is configured to detect light and output a signal that is indicative of light incident to the sensor array 750, such as an extended color filter array (XCFA) or a Bayer filter, and provide the sensor signals to an analog-to-digital (ADC) converter 752. The ADC 752 converts the analog sensor signals into a raw digital image. In one illustrative aspect, the ADC 752 may also receive a mask (e.g., mask 616) from a foveation controller 754. As illustrated in FIG. 7B, the foveation controller 754 receives information from the perception engine 642. Salient objects detected by the perception engine 642 may control the region of interest (ROI) for foveation. The information from the perception engine 642 can include a mask (e.g., mask 616), a scaling ratio (e.g., for downsampling), and other information such as interleaving, etc.

The foveation controller 754 provides the mask to the ADC 752 and, in response, the ADC 752 may be configured to read out the raw digital image from the ADC 752 based on the mask. For example, a pixel that corresponds to the black region of the mask is a peripheral region and is provided to a binner 756, and a pixel that corresponds to the transparent region is salient region and the pixel is provided to the interface 758. For example, the interface 758 is configured to receive a high-resolution output 703 (e.g., foveated pixels of a salient region) from the ADC 752. In some aspects, the ADC 752 may also receive additional information such as interleaving information that identifies whether a fraction of the images (e.g., ½, etc.) should be foveated.

The binner 756 is configured to receive the raw digital pixels from the ADC 752 and a control signal from the foveation controller 754 and generate a low-resolution image 704 (e.g., a binned image). In one illustrative aspect, the control signal can be a scaling factor (e.g., 2, 4, etc.) that identifies an amount of pixels to converge to decrease the size of the peripheral region. An interface circuit 758 is configured to receive and output the high-resolution output 703 and the low-resolution output 704 for an ISP (e.g., ISP 706), such as on different virtual channels. For example, as described herein, the high-resolution output 703 can be sent on a first virtual channel and the low-resolution output 704 can be sent on a second virtual channel.

In other aspects, the binning may occur within the ADC 752 itself based on data that is being read from a buffer. For example, as an image is being converted by the ADC and pixels can be temporarily stored in a buffer, and the readout of the pixels from the buffer can include a binning function that creates the high-resolution output 703 and the low-resolution output 704.

FIG. 8 illustrates an example block diagram of an XR system 800 with an image sensor 802 (e.g., a VST sensor) configured to provide a frame to an ISP 804 that performs foveation in accordance with some examples. FIG. 8 illustrates an example of foveating a frame or image into salient portions and peripheral portions based on a mask 806 provided from an ROI detection engine 808 that detected the salient region (e.g., ROI) of a previous frame. In some aspects, an image sensor 802 provides image data without any cropping to a front-end engine 810 that is part of an ISP 804. In some cases, the front-end engine 810 crops the frame into a salient region (corresponding to the ROI) and the peripheral region based on the mask 806. The front-end engine 810 may downscale or downsample the peripheral region stream to conserve bandwidth. The front-end engine 810 may process the salient region stream using fewer image signal processing operations for the peripheral region of the frame(s) as compared to image signal processing operations performed for the ROI/salient region of the frame(s), such as by perform basic corrective measures such as tone correction. The front-end engine 810 can identify the salient region/ROI based on the mask received from the ROI engine.

The front-end engine 810 may transmit a first stream including the salient region/ROI of the frame and a second stream including the peripheral region of the frame to a post-processing engine 814. In some cases, the salient region/ROI of the frame and a second stream including the peripheral region of the frame may need to be temporarily stored in the memory 812 until the images are required by the post-processing engine 814. In this example, the peripheral region consumes less memory based on the lower resolution, which saves energy by requiring the memory 812 to write less content and decreases bandwidth consumption. The post-processing engine 814 can read the salient region stream and the peripheral region stream in the memory 812 and process one or more of the streams. In some cases, the post-processing engine 814 can use the mask to control various additional processing functions, such as edge detection, color saturation, noise reduction, tone mapping, etc. In some aspects, the post-processing engine 814 is more computationally expensive and providing a mask 806 to perform calculations based on a particular region can significantly reduce the processing cost of various corrective measures. The post-processing engine 814 provides the processed frames to the blending engine 816 for blending the frames and other rendered content into a single frame, which is output to display panels of the XR system 800. The post-processing engine 814 also provides the processed frames to the ROI detection engine 808, which predicts a mask 806 for the next frame based on the processed frames and sensor information from various sensors.

In the illustrative aspects of FIG. 7A, the foveated sensing (resulting in foveation of the frame) is performed in the image sensor 702. In the illustrative aspects of FIG. 8, the foveated sensing/foveation of the frame is performed in the ISP 804 itself. The front-end engine 810 and the post-processing engine 814 divide the ISP 804 into two logical blocks to reduce the bandwidth of the image streams before storing the images into memory.

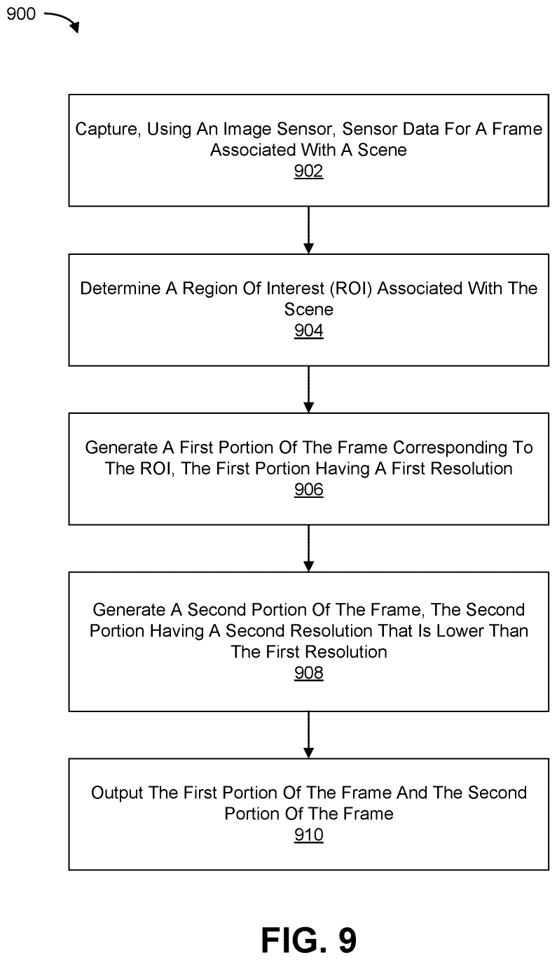

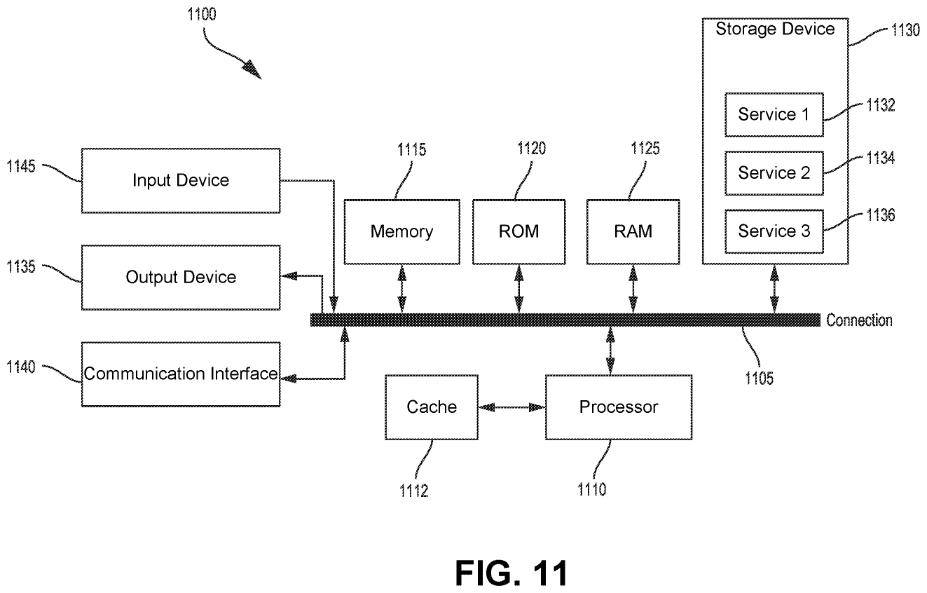

FIG. 9 is a flow chart illustrating an example of a process 900 for generating one or more frames using one or more of the foveated sensing techniques described herein. The process 900 can be performed by an image sensor (e.g., image sensor 130 of FIG. 1 or any of the image sensors discussed above with respect to FIGS. 6A-8) or by a component or system in combination with the image sensor. For instance, in some cases, the operations of the process 900 may be implemented as software components that are executed and run on one or more processors (e.g., processor 1110 of FIG. 11 or other processor(s)) in combination with an image sensor (e.g., image sensor 130 of FIG. 1 or any of the image sensors discussed above with respect to FIGS. 6A-7).

At block 902, the process 900 includes capturing, using the image sensor, sensor data (e.g., sensor data 603, 604 of FIG. 6A, sensor data 614 of FIG. 6B, the sensor data shown in FIG. 7A, the sensor data shown in FIG. 8, etc.) for a frame associated with a scene. At block 904, the process 900 includes obtaining information for a ROI associated with the scene. In some aspects, the process 900 includes determining the ROI associated with the scene using a mask associated with the scene. In some cases, the mask includes a bitmap (e.g., the bitmap mask 616 of FIG. 6B, the bitmap mask shown in FIG. 7A, the bitmap mask shown in FIG. 8, or other bitmap) including a first pixel value for pixels of the frame associated with the ROI and a second pixel value for pixels of the frame outside of the ROI. In some examples, the mask and/or the ROI is determined based on at least one of gaze information of a user, a predicted gaze of the user, an object detected in the scene, a depth map generated for the scene, and a saliency map of the scene, which can be obtained by the process 900 in some cases. In some aspects, the process 900 includes obtaining motion information from at least one sensor (e.g., rotation information from a gyroscope, eye position information from at least one eye sensor, movement information from a head motion sensor, any combination thereof, and/or other motion information) that identifies motion associated with a device including the image sensor or the eyes of the user and modifying the ROI based on the motion information. For instance, the process 1000 may include increasing a size of the ROI in a direction of the motion information. In one illustrative example, the process 900 may perform dilation as described above to modify the ROI based on the motion information (e.g., in a direction of the motion).

At block 906, the process 900 includes generating a first portion of the frame for the ROI. The first portion of the frame has a first resolution. At block 908, the process 900 includes generating a second portion of the frame. The second portion has a second resolution that is lower than the first resolution. In some cases, the first portion of the frame is a first version of the frame having the first resolution and the second portion of the frame is a second version of the frame having the second resolution, in which case the first version and the second version are different frames having different resolutions. In some cases, the process 900 includes combining a plurality of pixels of the sensor data (e.g., using binning, such as that described above with respect to FIG. 2A-2B or FIG. 3) in the image sensor such that the second portion of the frame has the second resolution.

At block 910, the process 900 includes outputting the first portion of the frame and the second portion of the frame from the image sensor. In some cases, outputting the first portion of the frame and the second portion of the frame includes outputting the first portion of the frame using a first virtual channel and outputting the second portion of the frame using a second virtual channel. In some aspects, the process 900 includes generating an output frame (e.g., using an ISP, a GPU, or other processor) at least in part by combining the first portion of the frame and the second portion of the frame. The ISP may include the ISP 154 or image processor 150 of FIG. 1 or any of the ISPs discussed above with respect to FIGS. 6A-8. In some aspects, the process 900 includes processing, using an ISP, the first portion of the frame based on first one or more parameters and processing the second portion of the frame based on second one or more parameters that are different from the first one or more parameters. In some aspects, the process 900 includes processing (e.g., using the ISP) the first portion of the frame based on first one or more parameters and refraining from processing of the second portion of the frame.

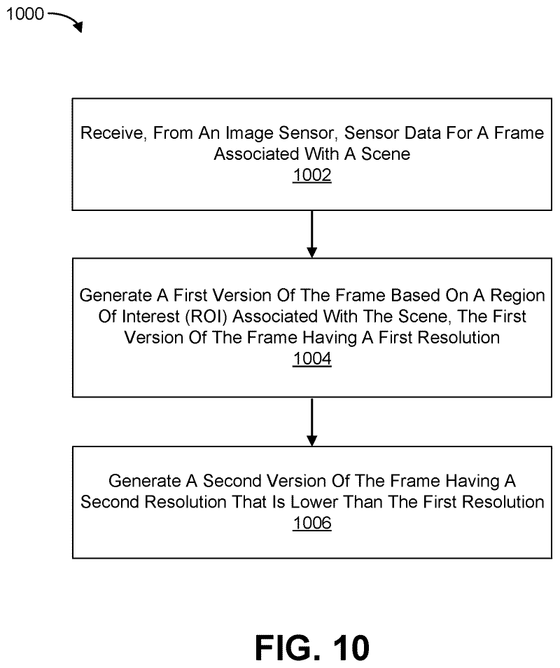

FIG. 10 is a flow chart illustrating an example of a process 1000 for generating one or more frames using one or more of the foveated sensing techniques described herein. The process 1000 can be performed by an ISP (e.g., the ISP 154 or image processor 150 of FIG. 1 or any of the ISPs discussed above with respect to FIGS. 6A-8) or by a component or system in combination with the ISP. For instance, in some cases, the operations of the process 1000 may be implemented as software components that are executed and run on one or more processors (e.g., processor 1110 of FIG. 11 or other processor(s)) in combination with an ISP (e.g., the ISP 154 or image processor 150 of FIG. 1 or the ISP discussed above with respect to FIG. 8).

At block 1002, the process 1000 includes receiving, from an image sensor (e.g., image sensor 130 of FIG. 1 or the image sensor discussed above with respect to FIG. 8), sensor data for a frame associated with a scene.

At block 1004, the process 1000 includes generating a first version of the frame based on a ROI associated with the scene. The first version of the frame having a first resolution. In some aspects, the process 1000 includes determining the ROI associated with the scene using a mask associated with the scene. In some cases, the mask includes a bitmap (e.g., the bitmap mask 616 of FIG. 6B, the bitmap mask shown in FIGS. 7A and 7B, the bitmap mask shown in FIG. 8, or other bitmap) including a first pixel value for pixels of the frame associated with the ROI and a second pixel value for pixels of the frame outside of the ROI. In some examples, the mask and/or the ROI is determined based on at least one of gaze information of a user, a predicted gaze of the user, an object detected in the scene, a depth map generated for the scene, and a saliency map of the scene, which can be obtained by the process 1000 in some cases. In some aspects, the process 1000 includes obtaining motion information from at least one sensor (e.g., rotation information from a gyroscope, eye position information from at least one eye sensor, movement information from a head motion sensor, any combination thereof, and/or other motion information) that identifies motion associated with a device including the image sensor or the eyes of the user and modifying the ROI based on the motion information. For instance, the process 1000 may include increasing a size of the ROI in a direction of the motion. In one illustrative example, the process 900 may perform dilation as described above to modify the ROI based on the motion information (e.g., in a direction of the motion). In some aspects, the ROI is identified from a previous frame. In some cases, the process 1000 includes determining an ROI for a next frame based on the ROI, where the next frame is sequential to the frame.

At block 1006, the process 1000 includes generating a second version of the frame having a second resolution that is lower than the first resolution. In some aspects, the process 1000 includes outputting the first version of the frame and the second version of the frame. For instance, the first version and the second version are different frames having different resolutions. In some aspects, the process 1000 includes generating an output frame (e.g., using the ISP, a GPU, or other processor) at least in part by combining the first version of the frame and the second version of the frame. In some aspects, the process 1000 includes generating the first version of the frame and the second version of the frame based on the mask.

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some cases, one or more of the described system components represents many such components each performing some or all of the function for which the component is described. In some aspects, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of generating one or more frames, comprising: capturing, using an image sensor, sensor data for a frame associated with a scene; generating a first portion of the frame based on information corresponding to a region of interest (ROI), the first portion having a first resolution; generating a second portion of the frame, the second portion having a second resolution that is lower than the first resolution; and outputting the first portion of the frame and the second portion of the frame.

Aspect 2. The method of Aspect 1, wherein the first portion of the frame is a first version of the frame having the first resolution and the second portion of the frame is a second version of the frame having the second resolution.

Aspect 3. The method of any of Aspects 1 to 2, wherein the image sensor outputs the first portion of the frame and the second portion of the frame.

Aspect 4. The method of any of Aspects 1 to 3, further comprising: receiving a mask associated with the scene, wherein the mask includes the information corresponding to the ROI associated with a previous frame.

Aspect 5. The method of any of Aspects 1 to 4, wherein the mask includes a bitmap including a first pixel value for pixels of the frame associated with the ROI and a second pixel value for pixels of the frame outside of the ROI.

Aspect 6. The method of any of Aspects 1 to 5, wherein the mask is determined based on at least one of gaze information of a user, a predicted gaze of the user, an object detected in the scene, a depth map generated for the scene, and a saliency map of the scene.

Aspect 7. The method of any of Aspects 1 to 6, further comprising generating, using an image signal processor, an output frame at least in part by combining the first portion of the frame and the second portion of the frame.

Aspect 8. The method of any of Aspects 1 to 7, further comprising processing, using an image signal processor, the first portion of the frame based on first one or more parameters and processing the second portion of the frame based on second one or more parameters that are different from the first one or more parameters.

Aspect 9. The method of any of Aspects 1 to 8, further comprising processing, using an image signal processor, the first portion of the frame based on first one or more parameters to improve visual fidelity of the first portion and refraining from processing of the second portion of the frame.

Aspect 10. The method of any of Aspects 1 to 9, wherein generating the second portion of the frame comprises: combining a plurality of pixels of the sensor data in the image sensor such that the second portion of the frame has the second resolution.

Aspect 11. The method of any of Aspects 1 to 10, wherein outputting the first portion of the frame and the second portion of the frame includes outputting the first portion of the frame using a first logical channel of an interface between the image sensor and an image signal processor and outputting the second portion of the frame using a second logical channel of the interface.

Aspect 12. The method of any of Aspects 1 to 11, further comprising: obtaining, using an image signal processor, motion information from at least one motion sensor that identifies motion associated with a device including the image sensor; and modifying the ROI based on the motion information.

Aspect 13. The method of any of Aspects 1 to 12, further comprising: obtaining, using an image signal processor, motion information from at least one motion sensor that identifies motion associated with eyes of a user; and modifying the ROI based on the motion information.

Aspect 14. The method of any of Aspects 1 to 13, wherein the image sensor is configured to generate the first portion of the frame and the second portion of the frame based on an instruction from a processor, wherein the processor receives an instruction that identifies a required framerate.

Aspect 15. The method of any of Aspects 1 to 14, wherein the required framerate exceeds a maximum bandwidth of a memory.

Aspect 16. The method of any of Aspects 1 to 15, wherein the image sensor is configured to generate the first portion of the frame and the second portion of the frame based on a minimum framerate associated with an application.

Aspect 17. The method of any of Aspects 1 to 16, wherein the application includes instructions to render a virtual image and combine the virtual image with a foveated frame generated from the first portion and the second portion.

Aspect 18. The method of any of Aspects 1 to 17, wherein the application includes instructions to generate a single frame for the scene when the application exits or ceases rendering of virtual images.

Aspect 19. The method of any of Aspects 1 to 18, wherein an image signal processor outputs the first portion of the frame and the second portion of the frame.

Aspect 20. The method of any of Aspects 1 to 19, further comprising: determining, by the image signal processor, the ROI associated with the scene based on motion information from at least one motion sensor that identifies motion associated with a device including the image sensor.

Aspect 21. The method of any of Aspects 1 to 20, wherein a mask includes a bitmap including a first pixel value for pixels of the frame associated with the ROI and a second pixel value for pixels of the frame outside of the ROI.

Aspect 22. The method of any of Aspects 1 to 21, further comprising: generating the first portion of the frame and the second portion of the frame based on the mask.

Aspect 23. The method of any of Aspects 1 to 22, wherein outputting the first portion of the frame and the second portion of the frame comprises storing the first portion of the frame and the second portion of the frame in a memory.

Aspect 24. The method of any of Aspects 1 to 23, further comprising generating an output frame at least in part by combining the first portion of the frame and the second portion of the frame.

Aspect 25. The method of any of Aspects 1 to 24, further comprising: determining the ROI based on at least one of gaze information of a user, a predicted gaze of the user, an object detected in the scene, a depth map generated for the scene, and a saliency map of the scene.

Aspect 26. The method of any of Aspects 1 to 25, further comprising: obtaining motion information from at least one motion sensor that identifies motion associated with a device including the image sensor; and modifying the ROI based on the motion information.

Aspect 27. The method of any of Aspects 1 to 26, further comprising: obtaining motion information from at least one motion sensor that identifies motion associated eyes of the user; and modifying the ROI based on the motion information.

Aspect 28. The method of any of Aspects 1 to 27, wherein modifying the ROI comprises: increasing a size of the ROI in a direction of the motion.

Aspect 29. The method of any of Aspects 1 to 28, wherein the ROI is identified from a previous frame.

Aspect 30. The method of any of Aspects 1 to 29, further comprising: determining an ROI for a next frame based on the ROI, wherein the next frame is sequential to the frame.

Aspect 31. The method of any of Aspects 1 to 30, further comprising: obtaining motion information from at least one motion sensor that identifies motion associated with eyes of a user; and modifying the ROI based on the motion information.

Aspect 32. The method of any of Aspects 1 to 31, wherein the image signal processor is configured to generate the first portion of the frame and the second portion of the frame based on an instruction from a processor, wherein the processor receives an instruction that identifies a required framerate.

Aspect 33. The method of any of Aspects 1 to 32, wherein the required framerate exceeds a maximum bandwidth of a memory.

Aspect 34. The method of any of Aspects 1 to 33, wherein the image signal processor is configured to generate the first portion of the frame and the second portion of the frame based on a minimum framerate associated with an application.

Aspect 35. The method of any of Aspects 1 to 34, wherein the application includes instructions to render a virtual image and combine the virtual image with a foveated frame generated from the first portion and the second portion.

Aspect 36. The method of any of Aspects 1 to 35, after the application includes instructions to generate a single frame for the scene when the application exits or ceases rendering of virtual images.

Aspect 37. An image sensor for generating one or more frames, comprising: a sensor array configured to capture sensor data for a frame associated with a scene; an analog-to-digital converter to convert the sensor data into the frame; a buffer configured to store at least a portion of the frame, wherein the image sensor is configured to: obtain information corresponding to a region of interest (ROI) associated with the scene; generate a first portion of the frame for the ROI, the first portion having a first resolution; generate a second portion of the frame, the second portion having a second resolution that is lower than the first resolution; and output the first portion of the frame and the second portion of the frame.

Aspect 38. The image sensor of Aspect 37, wherein the first portion of the frame is a first version of the frame having the first resolution and the second portion of the frame is a second version of the frame having the second resolution.

Aspect 39. The image sensor of any of Aspects 37 to 38, wherein the image sensor is configured to: generate an output frame at least in part by combining the first portion of the frame and the second portion of the frame.

Aspect 40. The image sensor of any of Aspects 37 to 39, wherein an image signal processor is configured to process the first portion of the frame based on first one or more parameters and process the second portion of the frame based on second one or more parameters that are different from the first one or more parameters.

Aspect 41. The image sensor of any of Aspects 37 to 40, wherein an image signal processor is configured to: process the first portion of the frame based on first one or more parameters and refrain from processing of the second portion of the frame.

Aspect 42. The image sensor of any of Aspects 37 to 41, wherein an image signal processor configured to: combine a plurality of pixels of the sensor data such that the second portion of the frame has the second resolution.

Aspect 43. The image sensor of any of Aspects 37 to 42, wherein, to output the first portion of the frame and the second portion of the frame, the image sensor is configured to: output the first portion of the frame using a first virtual channel; and output the second portion of the frame using a second virtual channel.

Aspect 44. The image sensor of any of Aspects 37 to 43, wherein an image signal processor is configured to: determine a mask associated with the ROI of the scene.

Aspect 45. The image sensor of any of Aspects 37 to 44, wherein the mask includes a bitmap including a first pixel value for pixels of the frame associated with the ROI and a second pixel value for pixels of the frame outside of the ROI.

Aspect 46. The image sensor of any of Aspects 37 to 45, wherein the mask is determined based on at least one of gaze information of a user, a predicted gaze of the user, an object detected in the scene, a depth map generated for the scene, and a saliency map of the scene.

Aspect 47. The image sensor of any of Aspects 37 to 46, wherein an image signal processor is configured to: obtain motion information from at least one motion sensor that identifies motion associated with a device including the image sensor; and modify the ROI based on the motion information.

Aspect 48. The image sensor of any of Aspects 37 to 47, wherein an image signal processor is configured to: obtain motion information from at least one motion sensor that identifies motion associated with eyes of a user; and modify the ROI based on the motion information.

Aspect 49. The image sensor of any of Aspects 37 to 48, wherein the image sensor is configured to generate the first portion of the frame and the second portion of the frame based on an instruction from a processor, wherein the processor receives an instruction that identifies a required framerate.

Aspect 50. The image sensor of any of Aspects 37 to 49, wherein the required framerate exceeds a maximum bandwidth of a memory.

Aspect 51. The image sensor of any of Aspects 37 to 50, wherein the image sensor is configured to generate the first portion of the frame and the second portion of the frame based on a minimum framerate associated with an application.

Aspect 52. The image sensor of any of Aspects 37 to 51, wherein an application includes instructions to render a virtual image and combine the virtual image with a foveated frame generated from the first portion and the second portion.

Aspect 53. The image sensor of any of Aspects 37 to 52, wherein the application includes instructions to generate a single frame for the scene when the application exits or ceases rendering of virtual images.

Aspect 54. An image signal processor for generating one or more frames, comprising: an interface circuit configured to receive, from an image sensor, a frame associated with a scene; and one or more processors coupled to the interface circuit, the one or more processors configured to: generate a first portion of the frame corresponding to a region of interest (ROI) associated with the scene, the first portion of the frame having a first resolution; and generate a second portion of the frame having a second resolution that is lower than the first resolution.

Aspect 55. The image signal processor of Aspect 54, wherein the first portion of the frame is a first version of the frame having the first resolution and the second portion of the frame is a second version of the frame having the second resolution.

Aspect 56. The image signal processor of any of Aspects 54 to 55, wherein the one or more processors are configured to: output the first portion of the frame and the second portion of the frame.

Aspect 57. The image signal processor of any of Aspects 54 to 56, wherein the one or more processors are configured to: generate an output frame at least in part by combining the first portion of the frame and the second portion of the frame.

Aspect 58. The image signal processor of any of Aspects 54 to 57, wherein the one or more processors are configured to: determine a mask associated with the ROI the scene.

Aspect 59. The image signal processor of any of Aspects 54 to 58, wherein the mask includes a bitmap including a first pixel value for pixels of the frame associated with the ROI and a second pixel value for pixels of the frame outside of the ROI.

Aspect 60. The image signal processor of any of Aspects 54 to 59, wherein the one or more processors are configured to: generate the first portion of the frame and the second portion of the frame based on the mask.

Aspect 61. The image signal processor of any of Aspects 54 to 60, wherein the one or more processors are configured to: determine the ROI based on at least one of gaze information of a user, a predicted gaze of the user, an object detected in the scene, a depth map generated for the scene, and a saliency map of the scene.

Aspect 62. The image signal processor of any of Aspects 54 to 61, wherein one or more processors are configured to: obtain motion information from at least one motion sensor that identifies motion associated with a device including the image sensor; and modify the ROI based on the motion information.

Aspect 63. The image signal processor of any of Aspects 54 to 62, wherein the one or more processors are configured to: obtain motion information from at least one motion sensor that identifies motion associated with a device including the image sensor or eyes of a user; and modify the ROI based on the motion information.

Aspect 64. The image signal processor of any of Aspects 54 to 63, wherein the one or more processors are configured to: increase a size of the ROI in a direction of the motion.

Aspect 65. The image signal processor of any of Aspects 54 to 64, wherein the ROI is identified from a previous frame.

Aspect 66. The image signal processor of any of Aspects 54 to 65, wherein the one or more processors are configured to: determine an ROI for a next frame based on the ROI, wherein the next frame is sequential to the frame.

Aspect 67. The image sensor of any of Aspects 54 to 66, wherein the image sensor is configured to generate the first portion of the frame and the second portion of the frame based on an instruction from a processor, wherein the processor receives an instruction that identifies a required framerate.

Aspect 68. The image sensor of any of Aspects 54 to 67, wherein the required framerate exceeds a maximum bandwidth of a memory.

Aspect 69. The image sensor of any of Aspects 54 to 68, wherein the image sensor is configured to generate the first portion of the frame and the second portion of the frame based on a minimum framerate associated with an application.

Aspect 70. The image sensor of any of Aspects 54 to 69, wherein an application includes instructions to render a virtual image and combine the virtual image with a foveated frame generated from the first portion and the second portion.

Aspect 71. The image sensor of any of Aspects 54 to 70, wherein the application includes instructions to generate a single frame for the scene when the application exits or ceases rendering of virtual images.

Aspect 72. A non-transitory computer-readable medium comprising instructions which, when executed by one or more processors, cause the one or more processors to perform operations according to any of Aspects 1 to 30.

Aspect 73. An apparatus comprising means for performing operations according to any of Aspects 1 to 30.

Aspect 1A. A method of generating one or more frames, comprising: capturing, using an image sensor, sensor data for a frame associated with a scene; obtaining information corresponding to a region of interest (ROI) associated with the scene; generating a first portion of the frame corresponding to the ROI, the first portion having a first resolution; generating a second portion of the frame, the second portion having a second resolution that is lower than the first resolution; and outputting the first portion of the frame and the second portion of the frame from the image sensor.

Aspect 2A. The method of Aspect 1A, further comprising generating an output frame at least in part by combining the first portion of the frame and the second portion of the frame.

Aspect 3A. The method of any one of Aspects 1A or 2A, further comprising processing, using an image signal processor, the first portion of the frame based on first one or more parameters and processing the second portion of the frame based on second one or more parameters that are different from the first one or more parameters.

Aspect 4A. The method of any one of Aspects 1A to 3A, further comprising processing the first portion of the frame based on first one or more parameters and refraining from processing of the second portion of the frame.

Aspect 5A. The method of any one of Aspects 1A to 4A, wherein generating the second portion of the frame comprises: combining a plurality of pixels of the sensor data such that the second portion of the frame has the second resolution.

Aspect 6A. The method of any one of Aspects 1A to 5A, wherein outputting the first portion of the frame and the second portion of the frame includes outputting the first portion of the frame using a first virtual channel and outputting the second portion of the frame using a second virtual channel.

Aspect 7A. The method of any one of Aspects 1A to 6A, further comprising: determining the ROI associated with the scene using a mask associated with the scene.

Aspect 8A. The method of Aspect 7A, wherein the mask includes a bitmap including a first pixel value for pixels of the frame associated with the ROI and a second pixel value for pixels of the frame outside of the ROI.

Aspect 9A. The method of any one of Aspects 7A or 8A, wherein the mask is determined based on at least one of gaze information of a user, a predicted gaze of the user, an object detected in the scene, a depth map generated for the scene, and a saliency map of the scene.

Aspect 10A. The method of any one of Aspects 1A to 9A, further comprising: obtaining motion information from at least one sensor that identifies motion associated with a device including the image sensor; and modifying the ROI based on the motion information.

Aspect 11A. A method of generating one or more frames at an image signal processor (ISP), comprising: receiving, from an image sensor, sensor data for a frame associated with a scene; generating a first version of the frame based on a region of interest (ROI) associated with the scene, the first version of the frame having a first resolution; and generating a second version of the frame having a second resolution that is lower than the first resolution.

Aspect 12A. The method of Aspect 11A, further comprising: outputting the first version of the frame and the second version of the frame.

Aspect 13A. The method of any one of Aspects 11A or 12A, further comprising generating an output frame at least in part by combining the first version of the frame and the second version of the frame.

Aspect 14A. The method of any one of Aspects 11A to 13A, further comprising:
determining the ROI associated with the scene using a mask associated with the scene.

Aspect 15A. The method of Aspect 14A, wherein the mask includes a bitmap including a first pixel value for pixels of the frame associated with the ROI and a second pixel value for pixels of the frame outside of the ROI.

Aspect 16A. The method of any one of Aspects 14A or 15A, further comprising: generating the first version of the frame and the second version of the frame based on the mask.

Aspect 17A. The method of any one of Aspects 11A to 16A, further comprising: determining the ROI based on at least one of gaze information of a user, a predicted gaze of the user, an object detected in the scene, a depth map generated for the scene, and a saliency map of the scene.

Aspect 18A. The method of any one of Aspects 11A to 17A, further comprising: obtaining motion information from at least one sensor that identifies motion associated with a device including the image sensor; and modifying the ROI based on the motion information.

Aspect 19A. The method of Aspect 18A, wherein modifying the ROI comprises: increasing a size of the ROI in a direction of the motion information.

Aspect 20A. The method of any one of Aspects 11A to 19A, wherein the ROI is identified from a previous frame.

Aspect 21A. The method of Aspect 20A, further comprising: determining an ROI for a next frame based on the ROI, wherein the next frame is sequential to the frame.

Aspect 22A. An apparatus for generating one or more frames, comprising: at least one memory; and one or more processors coupled to the at least one memory, the one or more processors configured to: capture, using an image sensor, sensor data for a frame associated with a scene; obtain information corresponding to a region of interest (ROI) associated with the scene; generate a first portion of the frame corresponding to the ROI, the first portion having a first resolution; generate a second portion of the frame, the second portion having a second resolution that is lower than the first resolution; and output the first portion of the frame and the second portion of the frame from the image sensor.

Aspect 23A. The apparatus of Aspect 22A, wherein the one or more processors are configured to: generate an output frame at least in part by combining the first portion of the frame and the second portion of the frame.

Aspect 24A. The apparatus of any one of Aspects 22A or 23A, wherein the one or more processors are configured to: process, using an image signal processor, the first portion of the frame based on first one or more parameters and process the second portion of the frame based on second one or more parameters that are different from the first one or more parameters.

Aspect 25A. The apparatus of any one of Aspects 22A to 24A, wherein the one or more processors are configured to: process the first portion of the frame based on first one or more parameters and refrain from processing of the second portion of the frame.

Aspect 26A. The apparatus of any one of Aspects 22A to 25A, wherein the one or more processors are configured to: combine a plurality of pixels of the sensor data such that the second portion of the frame has the second resolution.

Aspect 27A. The apparatus of any one of Aspects 22A to 26A, wherein, to output the first portion of the frame and the second portion of the frame, the one or more processors are configured to: output the first portion of the frame using a first virtual channel; and output the second portion of the frame using a second virtual channel.

Aspect 28A. The apparatus of any one of Aspects 22A to 27A, wherein the one or more processors are configured to: determine the ROI associated with the scene using a mask associated with the scene.

Aspect 29A. The apparatus of Aspect 28A, wherein the mask includes a bitmap including a first pixel value for pixels of the frame associated with the ROI and a second pixel value for pixels of the frame outside of the ROI.

Aspect 30A. The apparatus of any one of Aspects 28A or 29A, wherein the mask is determined based on at least one of gaze information of a user, a predicted gaze of the user, an object detected in the scene, a depth map generated for the scene, and a saliency map of the scene.

Aspect 31A. The apparatus of any one of Aspects 22A to 30A, wherein the one or more processors are configured to: obtain motion information from at least one sensor that identifies motion associated with a device including the image sensor; and modify the ROI based on the motion information.

Aspect 32A. An apparatus for generating one or more frames, comprising: at least one memory; and one or more processors coupled to the at least one memory, the one or more processors configured to: receive, from an image sensor, sensor data for a frame associated with a scene; generate a first version of the frame based on a region of interest (ROI) associated with the scene, the first version of the frame having a first resolution; and generate a second version of the frame having a second resolution that is lower than the first resolution.

Aspect 33A. The apparatus of Aspect 32A, wherein the one or more processors are configured to: output the first version of the frame and the second version of the frame.

Aspect 34A. The apparatus of Aspect any one of Aspects 32A or 33A, wherein the one or more processors are configured to: generate an output frame at least in part by combining the first version of the frame and the second version of the frame.

Aspect 35A. The apparatus of any one of Aspects 32A to 34A, wherein the one or more processors are configured to: determine the ROI associated with the scene using a mask associated with the scene.

Aspect 36A. The apparatus of Aspect 35A, wherein the mask includes a bitmap including a first pixel value for pixels of the frame associated with the ROI and a second pixel value for pixels of the frame outside of the ROI.

Aspect 37A. The apparatus of any one of Aspects 35A or 36A, wherein the one or more processors are configured to: generate the first version of the frame and the second version of the frame based on the mask.

Aspect 38A. The apparatus of any one of Aspects 32A to 37A, wherein the one or more processors are configured to: determine the ROI based on at least one of gaze information of a user, a predicted gaze of the user, an object detected in the scene, a depth map generated for the scene, and a saliency map of the scene.

Aspect 39A. The apparatus of any one of Aspects 32A to 38A, wherein one or more processors are configured to: obtain motion information from at least one sensor that identifies motion associated with a device including the image sensor; and modify the ROI based on the motion information.

Aspect 40A. The apparatus of Aspect 39A, wherein one or more processors are configured to: increase a size of the ROI in a direction of the motion information.

Aspect 41A. The apparatus of any one of Aspects 32A to 40A, wherein the ROI is identified from a previous frame.

Aspect 42A. The apparatus of Aspect 41A, wherein one or more processors are configured to: determine an ROI for a next frame based on the ROI, wherein the next frame is sequential to the frame.

Aspect 43A. A non-transitory computer-readable medium comprising instructions which, when executed by one or more processors, cause the one or more processors to perform operations according to any of Aspects 1A to 10A.

Aspect 44A. An apparatus comprising means for performing operations according to any of Aspects 1A to 10A.

Aspect 45A. A non-transitory computer-readable medium comprising instructions which, when executed by one or more processors, cause the one or more processors to perform operations according to any of Aspects 11A to 21A.

Aspect 46A. An apparatus comprising means for performing operations according to any of Aspects 1A to 10A and Aspects 11A to 21A.

Aspect 47A. A non-transitory computer-readable medium comprising instructions which, when executed by one or more processors, cause the one or more processors to perform operations according to any of Aspects 1A to 10A and Aspects 11A to 21A.

Aspect 48A. An apparatus comprising means for performing operations according to any of Aspects 1A to 10A and Aspects 11A to 21A.

1. A method of generating one or more frames, comprising:
capturing, using an image sensor, sensor data for a frame associated with a scene;
generating a first portion of the frame based on information corresponding to a region of interest (ROI), the first portion having a first resolution;
generating a second portion of the frame, the second portion having a second resolution that is lower than the first resolution; and
outputting the first portion of the frame and the second portion of the frame.

2. The method of claim 1, wherein the image sensor outputs the first portion of the frame and the second portion of the frame.

3. The method of claim 2, further comprising:
receiving a mask associated with the scene, wherein the mask includes the information corresponding to the ROI associated with a previous frame.

4. The method of claim 3, wherein the mask is determined based on at least one of gaze information of a user, a predicted gaze of the user, an object detected in the scene, a depth map generated for the scene, and a saliency map of the scene.

5. The method of claim 2, further comprising generating, using an image signal processor, an output frame at least in part by combining the first portion of the frame and the second portion of the frame.

6. The method of claim 2, further comprising processing, using an image signal processor, the first portion of the frame based on first one or more parameters to improve visual fidelity of the first portion and refraining from processing of the second portion of the frame.

7. The method of claim 2, wherein generating the second portion of the frame comprises:
combining a plurality of pixels of the sensor data in the image sensor such that the second portion of the frame has the second resolution.

8. The method of claim 2, wherein outputting the first portion of the frame and the second portion of the frame includes:
outputting the first portion of the frame using a first logical channel of an interface between the image sensor and an image signal processor; and
outputting the second portion of the frame using a second logical channel of the interface.

9. The method of claim 1, wherein an image signal processor outputs the first portion of the frame and the second portion of the frame.

10. The method of claim 9, further comprising:
determining, by the image signal processor, the ROI associated with the scene based on motion information from at least one motion sensor that identifies motion associated with a device including the image sensor.

11. The method of claim 9, further comprising:
determining the ROI based on at least one of gaze information of a user, a predicted gaze of the user, an object detected in the scene, a depth map generated for the scene, and a saliency map of the scene.

12. The method of claim 11, further comprising:
obtaining motion information from at least one motion sensor that identifies motion associated with a device including the image sensor; and
modifying the ROI based on the motion information.

13. The method of claim 11, further comprising:
obtaining motion information from at least one motion sensor that identifies motion associated with eyes of the user; and
modifying the ROI based on the motion information.

14. The method of claim 13, wherein modifying the ROI comprises:
increasing a size of the ROI in a direction of the motion.

15. The method of claim 9, further comprising:
obtaining motion information from at least one motion sensor that identifies motion associated with eyes of a user; and
modifying the ROI based on the motion information.

16. An apparatus for generating one or more frames, comprising:
at least one memory; and
at least one processor coupled to the at least one memory and configured to:
obtain, from an image sensor, sensor data for a frame associated with a scene;
obtain a first portion of the frame based on information corresponding to a region of interest (ROI), the first portion having a first resolution;
obtain a second portion of the frame, the second portion having a second resolution that is lower than the first resolution; and
output the first portion of the frame and the second portion of the frame.

17. The apparatus of claim 16, wherein the at least one processor is configured to obtain the first portion of the frame and the second portion of the frame from the image sensor.

18. The apparatus of claim 17, wherein the at least one processor is configured to:
receive a mask associated with the scene, wherein the mask includes the information corresponding to the ROI associated with a previous frame.

19. The apparatus of claim 18, wherein the at least one processor is configured to determine the mask based on at least one of gaze information of a user, a predicted gaze of the user, an object detected in the scene, a depth map generated for the scene, and a saliency map of the scene.

20. The apparatus of claim 17, wherein the at least one processor is an image signal processor and is configured to generate an output frame at least in part by combining the first portion of the frame and the second portion of the frame.

21. The apparatus of claim 17, wherein the at least one processor is configured to process, using an image signal processor, the first portion of the frame based on first one or more parameters to improve visual fidelity of the first portion and refraining from processing of the second portion of the frame.

22. The apparatus of claim 17, wherein, to generate the second portion of the frame, the at least one processor is configured to:
combine a plurality of pixels of the sensor data such that the second portion of the frame has the second resolution.

23. The apparatus of claim 17, wherein, to output the first portion of the frame and the second portion of the frame, the at least one processor is configured to:
output the first portion of the frame using a first logical channel of an interface between the image sensor and an image signal processor; and
output the second portion of the frame using a second logical channel of the interface.

24. The apparatus of claim 16, wherein an image signal processor is configured to output the first portion of the frame and the second portion of the frame.

25. The apparatus of claim 24, wherein the at least one processor is configured to:
determine, by the image signal processor, the ROI associated with the scene based on motion information from at least one motion sensor that identifies motion associated with a device including the image sensor.

26. The apparatus of claim 24, wherein the at least one processor is configured to:
determine the ROI based on at least one of gaze information of a user, a predicted gaze of the user, an object detected in the scene, a depth map generated for the scene, and a saliency map of the scene.

27. The apparatus of claim 26, wherein the at least one processor is configured to:
obtain motion information from at least one motion sensor that identifies motion associated with a device including the image sensor; and
modify the ROI based on the motion information.

28. The apparatus of claim 26, wherein the at least one processor is configured to:
obtain motion information from at least one motion sensor that identifies motion associated with eyes of the user; and
modify the ROI based on the motion information.

29. The apparatus of claim 28, wherein, to modify the ROI, the at least one processor is configured to:
increase a size of the ROI in a direction of the motion.

30. The apparatus of claim 24, wherein the at least one processor is configured to:
obtain motion information from at least one motion sensor that identifies motion associated with eyes of a user; and
modify the ROI based on the motion information.
